(19) United States
(12) Patent Application Publication
(10) Pub. No.: US 2021/0390392 A1
(43) Pub. Date: Dec. 16, 2021

(54) SYSTEM AND METHOD FOR PROCESSING POINT-OF-INTEREST DATA

(71) Applicant: NAVER CORPORATION, Seongnam-si (KR)

(72) Inventors: Nikolaos LAGOS, Grenoble (FR); Salah AIT-MOKHTAR, Montbonnot-Saint-Martin (FR); Ioan CALAPODESCU, Grenoble (FR)

(21) Appl. No.: 17/082,874

(22) Filed: Oct. 28, 2020

Related U.S. Application Data
(60) Provisional application No. 63/039,251, filed on Jun. 15, 2020.

(51) Int. Cl. G06N 3/08; G06N 3/04; G06F 16/245; G06F 16/248; G06F 16/29

(52) U.S. Cl. CPC G06N 3/08; G06N 3/04; G06Q 30/0623; G06F 16/248; G06F 16/29; G06F 16/245

(57) ABSTRACT

Methods employing temporal and/or cultural data are provided for automatically assigning one or more semantic tags to a point-of-interest (POI) using a processor. The POI is represented by attribute data. A dataset including temporal attribute data and/or cultural data is provided to a multilabel classifier comprising a neural network model. One or more predicted semantic tags for the POI are received from an output of the multilabel classifier. The predicted semantic tags are stored in a database as additional attribute data of the POI.

### PRIORITY CLAIM AND REFERENCE TO RELATED APPLICATION

This application claims priority of U.S. Provisional Patent Application Ser. No. 63/039,251, filed Jun. 15, 2020, which application is incorporated herein by reference in its entirety.

### FIELD

The present disclosure relates to automated data processing using machine learning, and more particularly to methods and systems for automatically assigning semantic tags to points-of-interest (POIs).

### BACKGROUND

Applications that employ Point-of-Interest (POI) data for use in performing computing services are widely known. Example computing services include search engines, digital maps, recommender systems (e.g., for recommending places to visit), and artificial intelligence (AI) personal assistants, among others.

One common source of POI data is a database that is accessible to the computing device(s) performing a service. The database can include POI data entities, each including a plurality of attributes represented by stored data. Among such attributes, semantic attributes represented by semantic tags such as POI categories are especially useful for facilitating computing services related to the POIs such as those mentioned above. Semantic tags are not only used to guide human users but also as input data to such applications.

The success of these applications critically depends on the quality of the data consumed, and most significantly the completeness of supporting databases. However, POI information in such databases is often incomplete or noisy (that is, it can include incorrect information) regarding such semantic tags. This is of particular concern when, for instance, the databases are populated at least in part using crowdsourced data.

### SUMMARY

According to one aspect of the disclosed embodiments, methods employing temporal data are provided for automatically assigning one or more semantic tags to a point-of-interest (POI) using a processor. The POI is represented by attribute data comprising temporal attribute data and one or more of spatial attribute data or metadata. The attribute data for the POI is received and provided to a multilabel classifier comprising a neural network model.

One or more predicted semantic tags for the POI are received from an output of the multilabel classifier. The predicted semantic tags are stored in a database as additional attribute data of the POI.

According to another aspect of the disclosed embodiments, methods employing cultural data are provided for automatically assigning one or more semantic tags to a point-of-interest (POI) using a processor. The POI is represented by attribute data stored in a database. A request is received from a user via a user terminal, and cultural data for the user is received. In response to the request, the attribute data for the POI from the database is received.

A dataset is generated including data corresponding to a selected set of attributes from the received cultural data and the received attribute data for the POI. The selected set of attributes comprises a POI name for the POI and at least one cultural attribute, wherein the data corresponding to the at least one cultural attribute in the generated dataset is generated from the received cultural data.

The generated dataset is provided to a multilabel classifier comprising a neural network model. The multilabel classifier is trained for predicting one or more semantic tags for each of a plurality of POIs in the database using a plurality of training sets, wherein each training set corresponds to the selected set of attributes, and wherein the data corresponding to the at least one cultural attribute in each of the training sets is generated from culture-related POI attributes.

According to a complementary aspect, the present disclosure provides a computer program product, comprising code instructions to execute a method according to the previously described aspects; and a computer-readable medium, on which is stored a computer program product comprising code instructions for executing a method according to the previously defined aspects.

Other features and advantages of the invention will be apparent from the following specification taken in conjunction with the following drawings.

### DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 illustrates an example of a system architecture in which POI semantic tag prediction models according to the present disclosure may be performed;

FIG. 2 sets forth components of an example processor;

FIG. 3 illustrates an example method for automatic POI semantic tag completion;

FIG. 4 illustrates an example method for training a POI semantic tag prediction model;

FIG. 5 illustrates a distribution of semantic tags for POIs in a POI dataset used in example experiments;

FIG. 6 shows Micro-precision scores over 10 runs (Center lines show the medians, box limits indicate the 25th and 75th percentiles as determined by R software. Whiskers extend 1.5 times the interquartile range (IQR) from the 25th and 75th percentiles, outliers are represented by dots. The notches are defined as +/−1.58*IQR/sqrt(n) and represent the 95% confidence interval for each median. Non-overlapping notches give roughly 95% confidence that two medians differ; i.e., in 19 out of 20 cases the population medians (estimated based on the samples) are in fact different. n=10 sample points);

FIG. 7 shows Micro-F1 scores over 10 runs;

FIG. 8A shows Tex-Mex opening time distribution in Mexico, and FIG. 8B shows the US opening time distribution. Differences in early and late opening times and some days (especially Thursday) help to further improve the predictions;

FIG. 9 shows POIs in Paris having example predictions for the semantic tag “Noodle House” that were indicated as incorrect in a silver standard evaluation due to label incompleteness, including a cluster of predictions centered at the 13^{th} arrondissement near a POI in which “Noodle House” exists as a semantic tag in the POI database;

FIG. 10 shows an example method for POI semantic tag prediction using culture-aware data, according to another embodiment;

FIG. 11 shows percentages of category labels related to the token “noodle” in Japan and France from the Foursquare database;

FIG. 12 shows an example method for training a neural network based POI category completion model;

FIG. 13 shows example online and offline methods for inference using the model trained in FIG. 12;

FIG. 14 shows the overall distribution of POIs in an example POI dataset and the one of the top categories in the distribution;

FIG. 15 shows culture-specific prediction results for different POI categories, where values highlighted with horizontal shading are significantly higher than in the rest of the cultures, and values highlighted with vertical shading significantly lower, indicating a notable culture-specific influence;

FIG. 16 shows an example semantic tag (e.g., POI category) correction and/or recommendation method;

FIG. 17 is a visualization of categories after PCA and t-SNE dimensionality reduction, where different colors stand for different categories;

FIG. 18 is a zoomed-in visualization of Japanese, Asian, and other related categories (zone 1) in FIG. 17;

FIG. 19 is a zoomed-in visualization of Pub, Irish Pub, and related categories (zone 2) in FIG. 17; and

FIG. 20 shows an example method for generating POIs in response to a search request including one or more POI categories.

In the drawings, reference numbers may be reused to identify similar and/or identical elements.

### DETAILED DESCRIPTION

### Introduction

An approach for addressing the problem of incomplete or incorrect information for POIs is to curate the POI data by providing a prediction of one or more semantic tags. An example semantic tag is a tag representing a POI category. Predictions can be provided automatically. The predicted semantic tags can be used to update stored POI attribute data, e.g., by correcting (replacing) or supplementing existing semantic tags stored in a database. As another example, the predicted semantic tags can be presented to a user, for instance as suggestions, and user feedback can be received. If one or more of the presented suggestions are accepted, the stored POI attribute data can be updated accordingly.

Existing approaches, though, have been insufficient for making such predictions. One reason, recognized by the present inventors, is that POI data entities can have many distinctive properties, including but not limited to multiscript names, geo-spatial identity, and contextual information, each of which can make effective data curation challenging.

Contextual information, for instance, can be useful for increasing the quality of automatic category predictions. However, some contextual information either may not be readily available, or obtaining such information may introduce other concerns. For instance, some previously disclosed methods for providing contextual information use personal user information, such as users' check-in information, e.g., location and time of visit, and sometimes user demographic information (e.g., age range, gender).

For example, two general approaches have been employed in conventional POI categorization methods for Location-Based Social Networks (LSBNs). A first approach requires access to user check-in data (that is, data representing user visits to a POI, usually explicitly declared by the user where geo-coordinates and time of visit are recorded) and uses this check-in data as alone input to a prediction model, while another approach uses both check-in data and more fine-grained information about the POIs. Both of these general approaches assume access to user information and use such information to infer similarity between different POIs based on the hypothesis that users with similar behavior tend to visit similar places. User check-in data may not be available in all instances, though, due to privacy or other restrictions.

In contrast to the above approaches, example methods provided herein exploit a recognition that POIs are not only geo-spatial but also temporally defined entities, and that temporal information can be exploited from POI attributes, such as opening hours or access hours. Accordingly, instead of simple text token-based processing, as in some conventional methods, example methods provide unique processing incorporating temporal information, or both spatial and temporal (referred to herein as spatio-temporal) information.

Temporal or spatio-temporal data can often be obtained without requiring access to a third-party resource such as an external corpus populated with user check-in data. For example, such information may be obtainable solely from public information about the POIs. Example methods provided herein can use temporal or spatio-temporal data either alone or in addition to other data, such as but not limited to categorical and sequential non-numerical data (i.e. unstructured text) to automatically predict semantic tags for POIs. Example methods can complement previous techniques based on user check-ins, but can also be independently used in the case that no such data is available.

Example methods can also exploit a recognition that POI category completion can be a multi-label multi-class classification problem, and that POI label sets in existing POI databases can be incomplete. Thus, training data for POI databases should not be considered as ground truth. Some prior approaches for category completion (e.g., for item categorization and imputation), in contrast, use only a single-label setting.

Additionally, conventional semantic tag prediction approaches for POIs typically deal only with one language. If more than one language is to be considered, multiple, separate prediction models may be created. However, corresponding databases are often global, multi-lingual, and multi-script. Thus, some example methods herein employ a different approach to token-based representations. Example methods can be based on a character-based model, which makes it flexible and robust to be used with different languages and scripts.

The predicted semantic tags can be used for one or more of category completion, correction, and/or hierarchy refinement/creation, and neural models according to example models may be configured for providing any or all of these. Example methods can further provide automatic data curation for POI datasets by completing or correcting the category information of a POI (e.g., a restaurant, bar, etc.) and refine or create a hierarchy of such categories (e.g., Indian restaurant as a subset of restaurant). Such data curation can be provided without the need to first provide user (personal) information, such as user feedback or check-ins.

In other example methods provided herein, cultural data is considered as a contextual parameter for automatically predicting semantic tags for POIs. As with the above described temporal data-based methods, cultural data-based example methods do not require access to user information at training time. Such methods can be used in combination with the above temporal data-based methods or other methods for categorizing (or applying to other database fields, such as open hours) POIs and their applications as disclosed herein.

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

### REFERENCES

The following documents are incorporated herein by reference in their entirety. Reference to such documents is not an admission that any of the documents qualify as prior art.

Interquartile range: Outliers. see website: en.wikipedia.orgwiki/Interquartile_range, accessed Nov. 6, 2019.

J. Armand, G. Edouard, B. Piotr, N. Maximilian, M. Tomas, ‘Fast Linear Model for Knowledge Graph Embeddings,’ arXiv-1710.10881, October 2017.

F. Biessmann, D. Salinas, S. Schelter, P. Schmdt, D. Lange, ‘Deep learning for missing value imputation in tables with non-numerical data,’ in Proceedings of the 27^{th} ACM International Conference on Information and Knowledge Management, CIKM '18, pp. 2017-2025, New York, N.Y., USA (2018).

C. M. Bishop, Pattern Recognition and Machine Learning (Information Science and Statistics), 105-110, Springer-Verlag, Berlin, Heidelberg, 2006.

A. E. Cano, A. Varga, F. Ciravegna, ‘Volatile classification of point of interests based on social activity streams,’ in In Proceedings of the 10^{th} International Semantic Web Conference, Workshop on Social Data on the Web (SDoW), 2011.

Ali Cevahir and Koji Murakami, ‘Large-scale multi-class and hierarchical product categorization for an e-commerce giant,’ in Proceedings of COLING 2016, the 26^{th} International Conference on Computational Linguistics: Technical Papers, pp. 525-535, 2016.

Jung-Woo Ha, Hyuna Pyo, Jeonghee Kim, ‘Large-scale item categorization in e-commerce using multiple recurrent neural networks,’ in Proceedings of the 22^{nd} ACM SIGKDD International Conference on Knowledge Discovery and Data Mining, KDD '16, pp. 107-115, New York, N.Y., USA, 2016.

T. He, H. Yin, Z. Chen, X. Zhou, S. Sadiq, B. Luo, ‘A spatial-temporal topic model for the semantic annotation of POIs in LBSNs,’ ACM Trans. Intell. Syst. Technol., 8(1), 12:1-12:24, 2016.

S. Jiang, A. Alves, F. Rodrigues, J. Ferreira, F. C. Pereira, ‘Mining point-of-interest data from social networks for urban land use classification and disaggregation,’ Computers, Environment and Urban Systems, 53, 36-46, 2015.

D. Kingma and J. Ba, ‘Adam: a method for stochastic optimization,’ arXiv.1412.6980, 15, 2015.

Markus Schedl, Dominik Schnitzer, ‘Location-Aware Music Artist Recommendation,” In Proceedings of the 20^{th} Anniversary International Conference on MultiMedia Modeling—Volume 8326 (MMM 2014), Springer-Verlag New York, Inc., New York, N.Y., USA, 205-213.

Eva Zangerle, Martin Pichl, Markus Schedl, ‘Culture-Aware Music Recommendation,’ In Proceedings of the 26^{th} Conference on User Modeling, Adaptation and Personalization (UMAP '18), ACM, New York, N.Y., USA, 357-358.

J. Zhou, S. Gou, R. Hu, D. Zhang, J. Xu, X. Wu, A. Jiang, H. Xiong, ‘A Collaborative Learning Framework to Tag Refinement for Points of Interest, 2019.

J. Krumm and D. Rouhana, ‘Placer Semantic place labels from diary data,’ in Proceedings of the 2013 ACM International Joint Conference on Pervasive and Ubiquitous Computing,’ UbiComp '13, pp. 163-172, New York, N.Y., USA, 2013.

Ouadie Gharroudi, ‘Ensemble multi-label learning in supervised and semi-supervised settings,’ Ph.D. dissertation, Universite de Lyon, 2017.

Hofstede G. J. Mindov, M. Hofstede, G. Cultures and organizations: Software of the mind, McGraw-Hill, New York, 2010.

Hannu Jaakkola, Bernhard Thalheim, ‘Supporting culture-aware information search,’ Frontiers in Artificial Intelligence and Applications, vol. 292, IOS Press, Netherlands, 161-181.

H. Paulheim, ‘Knowledge graph refinement: A survey of approaches and evaluation methods,’ Semantic Web, 8, 489-508, 2016.

N. Polyzotis, S. Roy, S. E. Whang, M. Zinkevich, ‘Data lifecycle challenges in production machine learning: A survey,’ SIGMOD Rec., 47(2), 17-28, December 2018.

A. Rahimi, T. Baldwin, T. Cohn, “Continuous representation of location for geolocation and lexical dialectology using mixture density networks,’ in Proceedings of the 2017 Conference on Empirical Methods in Natural Language Processing, pp. 167-176, Association for Computational Linguistics, 2017.

D. Shen, J.-D. Ruvini, B. Sarwar, ‘Large-scale item categorization for e-commerce,’ in Proceedings of the 21^{st} ACM International Conference on Information and Knowledge Management, CIKM '12, pp. 595-604, New York, N.Y., USA, 2012.

Michaela Spitzer, Jan Wildenhain, Juri Rappsilber, Mike Tyers, ‘Boxplotr A web tool for generation of box plots,’ Nature Methods, 11, 121-122, 2014.

E. Spyromitros, G. Tsoumakas, I. Vlahavas, ‘An empirical study of lazy multilabel classification algorithms,’ in Proc. 5^{th} Hellenic Conference on Artificial Intelligence (SETN 2008), 2008.

P. Tsangaratos, D. Rozos, A. Benardos, ‘Use of artificial neural network for spatial rainfall analysis,’ Journal of Earth System Science, 123(3), 457-465, 2014.

D. Wang, J. Zhang, W. Cao, J. Li, Y. Zheng, ‘When will you arrive? Estimating travel time based on deep neural networks,’ in Proceedings of the Thirty-Second AAAI Conference on Artificial Intelligence (AAAI-18), the 30′ innovative Applications of Artificial Intelligence (IAAI-18), and the 18^{th} AAAI Symposium on Educational Advances in Artificial Intelligence (EAAI-18), New Orleans, La., USA, February 2018, eds. Sheila A. McIlraith and Kilian Q. Weinberger, pp. 2500-2507, AAAI Press, 2018.

Y. Wang, Z. Qin, J. Pang, Y. Zhang, J. Xin, ‘Semantic annotation for places in Ibsn through graph embedding,’ in Proceedings of the 2017 ACM on Conference on Information and Knowledge Management, CIKM '17, pp. 2343-2346, New York, N.Y., USA, 2017.

M. Ye, D. Shou, W-C. Lee, P. Yin, K. Janowicz, ‘On the semantic annotation of places in location-based social networks,’ in Proceedings of the 17^{th} ACM SIGKDD International Conference on Knowledge Discovery and Data Mining, KDD '11, pp. 520-528, New York, N.Y., USA, 2011.

J. Zhang, Y. Zheng, D. Qi, R. Li, X. Yi, ‘Dnn-based prediction model for spatio-temporal data,’ in Proceedings of the 24^{th} ACM SIGSPATIAL International Conference on Advances in Geographic Information Systems, SIGSPACIAL '16, pp. 92:1-92:4, New York, N.Y., USA, 2016.

X. Zheng, J. Han, A. Sun, ‘A survey of location prediction on twitter,’ IEEE Transactions on Knowledge and Data Engineering, 30(9), 1652-1671, September 2018.

System Architecture

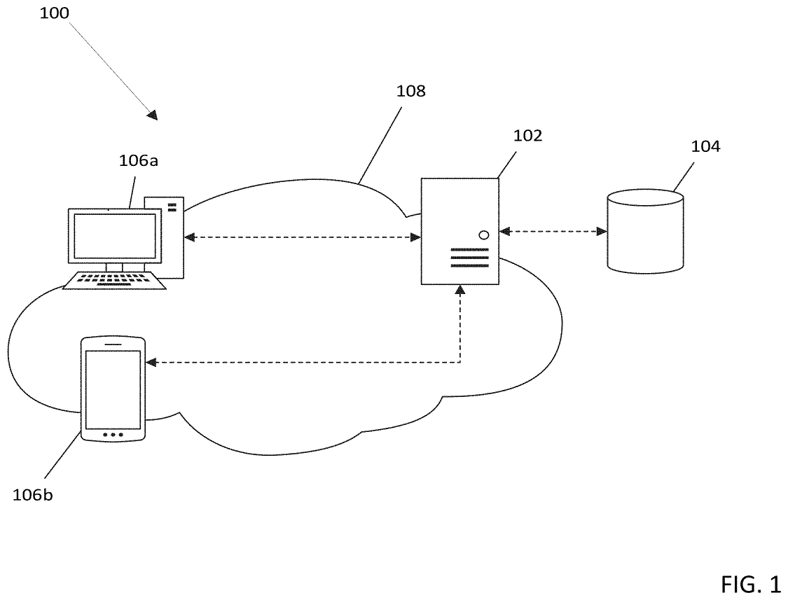

Referring now to the figures, example methods disclosed hereunder may be implemented within a system 100 architected as illustrated in FIG. 1. The system 100 includes a processor 102, e.g., a computing device, that is configured to perform example POI semantic tag completion and/or completion model training methods, where the models use one or more neural networks. The processor 102 can communicate with one or more databases 104 that store datasets of POI data (e.g., POI data entities, each including attribute data). Databases storing datasets for POIs are also referred to as “POI databases” herein. The datasets can be used for responding to a user input (e.g., a search request, a submitted POI review, a proposed POI semantic tag, etc.), used for training example POI semantic tag completion models, and/or updated (e.g., corrected or supplemented) using example POI semantic tag completion models. It will be appreciated that the processor 102 can include either a single processor or multiple processors operating in series or in parallel, and that the database 104 can include one or more databases.

During an operation of POI semantic tag prediction tasks such as training, validation, testing, and/or inference using the models, or related tasks such as POI semantic tag completion, correction, or recommendation, the processor 102 can receive input data from another, connected processor (not shown), from the databases 104, and/or from one or more user terminals 106 connected via a network 108, or any combination. The processor 102 can process the input data using the model, and then output results of such processing, such as predicted POI semantic tags or downstream results applying such predicted semantic tags, to the additional processor(s), the databases 104, and/or the one or more user terminals 106a, 106b. In some example methods, the processor 102 can be configured as a server (or cloud computing device) and one or more of the additional processors or the one or more user terminals 106 can be configured as clients. In some example embodiments provided herein, training of the POI semantic tag completion models can be performed offline, while inference is performed online. The databases 104 may be local to the processor, or connected remotely, e.g., via the network 108.

User terminals 106a, 106b include, but are not limited to, personal computers 106a, client computers, client terminals, mobile communication devices 106b, etc., or any other computing device that can be configured for sending and receiving data to the processor 102 according to methods herein. The user terminals 106 may include a display for displaying results of processing by the processor 102 according to example methods.

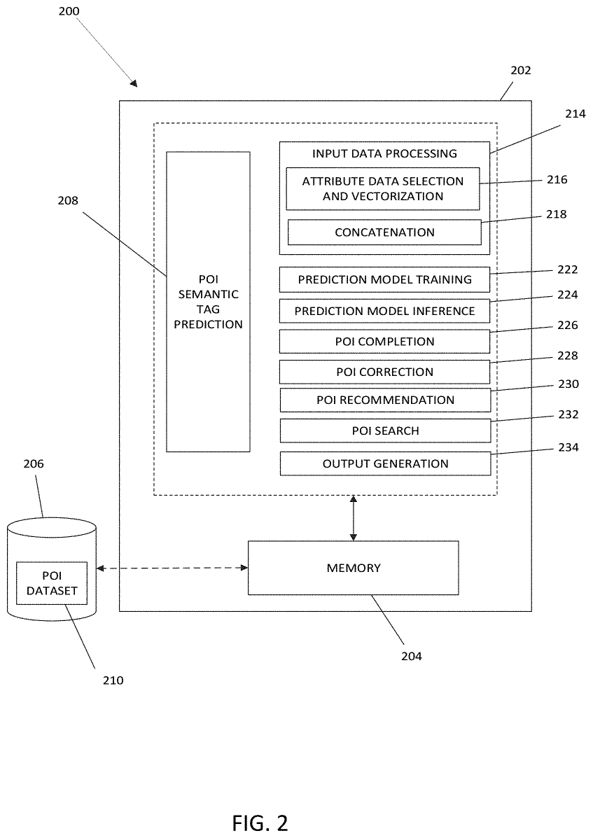

FIG. 2 shows components of an example processor 200, such as may be embodied in the processor 102. The processor 200 includes a processing unit 202 and a memory 204, which can include any combination of random access memory, non-volatile memory, and storage media. A database 206, such as the database 104, may be provided in communication with the processing unit 202. POI semantic tag completion model configuration data (e.g., models, parameters), datasets (e.g., POI datasets for training, testing, and/or validation), generated input data, generated output data, or other data can be stored in and retrieved from any combination of the memory 204 and the database 206 as needed.

The processing unit 202, executing code stored in the memory 204, provides modules for performing one or more steps of example methods herein. Example operations of such modules are explained in further detail below with reference to example methods.

A POI semantic tag prediction module 208 executes a neural network-based model for predicting POI semantic tags. The POI semantic tag prediction module 208 receives input data generated from one or more POI datasets 210, which may be stored in the database 206, in the memory 204, or a combination. Additional input data in some example methods may also be generated from received user data. The POI semantic tag prediction module 208 processes the input data to generate output data.

An input data processing module 214 receives and processes data, e.g., attribute data for one or more POIs from the POI datasets 210 and/or from memory 204 (and in some methods from received user data), and generates input data, such as an input dataset. This input data is provided to the POI semantic tag prediction module 208 for model training, testing, validation, and/or inference. The input data processing module 210 can include one or more data processing modules such as an attribute data selection and vectorization module 216 and a concatenation module 218.

The attribute data selection and vectorization module 216 selects relevant attribute data from the received POI dataset 210 or from new POI attribute data in memory 204 (and in some methods also user data) and vectorizes the selected attribute data. The concatenation module 218 then concatenates the vectorized attribute data to generate an input dataset for inputting to the POI semantic tag prediction module 208. Example methods for attribute data selection, vectorization, and concatenation are provided herein.

A POI semantic tag prediction model training module 222 trains the POI semantic tag prediction model executed by the POI semantic tag prediction module 206 using generated input data (e.g., datasets as processed by the input data processing module 214) in accordance with one or more training methods as provided herein. The POI semantic tag prediction training module 222 can also be configured for testing and/or validation of the POI semantic tag prediction model using additional input data.

A POI semantic tag prediction inference module 224 provides generated input data (e.g., datasets as processed by the input data processing module 214) to the POI semantic tag prediction module 206 for performing inference (e.g., POI semantic tag imputation), and receives an output such as one or more predicted POI semantic tags. The received predicted semantic tags can be stored, e.g., in memory 204 and/or the stored POI dataset 201.

Further, the received predicted semantic tags can be processed to provide one or more additional applications. For example, a POI completion module 226 can be provided for completing POI semantic tag attribute data in one or more POI datasets by assigning one or more of the predicted semantic tags to the associated POI in the POI dataset as an additional attribute. These assigned semantic tags can be stored with the POI datasets. A POI correction module 228 can be provided for correcting one or more stored or proposed POI semantic tags using the predicted POI semantic tags. A POI recommendation module 230 can be provided for recommending one or more of the predicted POI semantic tags, e.g., to a user. A POI search module 232 can be provided for performing one or more POI searches (e.g., of the POI dataset 210 or other data store) in response to a user search request, where the search is based at least partly on the predicted semantic tags for one or more POIs.

An output generation module 234 communicates with another processor and/or with the database 206 to store or transmit output POI attribute data. Alternatively or additionally, the output generation module 234 can generate a user interface to provide information to a user from one or more of the POI completion module 226, the POI correction module 228, the POI recommendation module 230, or the POI search module 234. An example user interface generation can include, for instance, providing a visualization for display on a display of the user terminal device 106a, 106b.

Automatic POI Semantic Tao Completion Using Spatial and Temporal Data

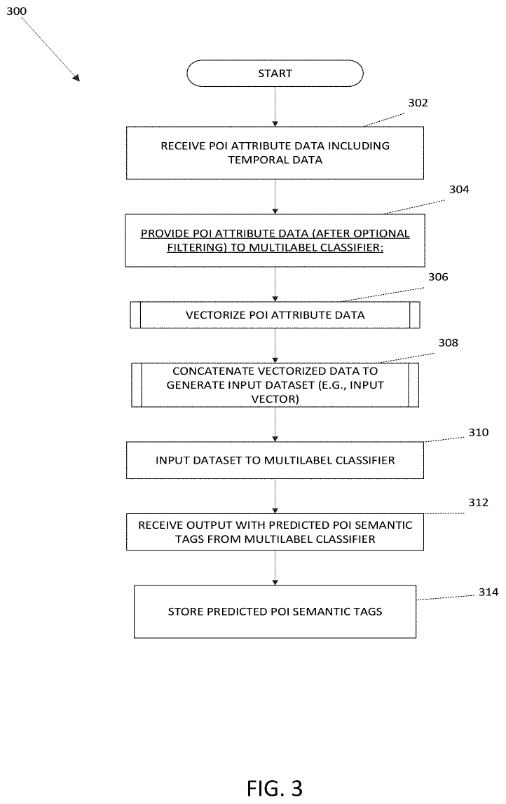

FIG. 3 illustrates an example method 300 for completing point-of-interest (POI) semantic tag data by automatically assigning one or more semantic tags to a POI. “Automatically” as used herein refers to the assignment of semantic tags being performed without a specific request by a user to do so. Performing the method 300 can be in response to, for instance, receiving stored POI data, e.g., from a data storage, and/or in response to receiving user data regarding a stored POI, such as data representing a POI, a search request for a POI, a proposed semantic tag or other attributes for the POI, or other user inputs. Example methods can be performed offline or online. The method 300 can be implemented using a processor such as processor 102.

The POI can be provided (e.g., represented) in a data storage, such as the database 104, as attribute data. This attribute data can include semantic data as represented by one or more semantic tags. Semantic tags can include, for instance, category labels for the POI, such as labels taken from a label set stored in the data storage. A set of semantic tags for the POI can include one or more observed semantic tags that may exist in the data storage for the POI before performing the method 300. However, the existing set of semantic tags for POIs prior to performing the method 300 may be incomplete.

The attribute data for the POI is received at 302, e.g., by the processor 102. This attribute data may be all of the attribute data associated with the POI, or a selected subset of such data. Received attribute data may be filtered to remove extraneous data. The received attribute data includes temporal attribute data and one or more of spatial attribute data or metadata. Example metadata for the POI includes, but is not limited to, semantic tags for the POI, a unique identifier, and/or a name of the POI (referred to herein as a POI name). Example temporal attribute data includes, but is not limited to opening times, closing times, and/or access times for the POI. Example spatial attribute data includes, but is not limited to, geospatial data such as geospatial coordinates, geographic regions, images of the POI, etc.

The received attribute data is provided at 304 to a multilabel classifier that includes a neural network model. The multilabel classifier allows the example method 300 to predict multiple labels, i.e., semantic tags, for the POI. In this way, even if a POI has previously been assigned a single (observed) semantic tag, the multilabel classifier can provide a complete labelset of predicted semantic tags to supplement and/or correct the single semantic tag. Example neural network-based multilabel classifiers are provided herein.

The providing 304 can include one or more data processing steps for processing the received attribute data. In an example method, the received attribute data is vectorized at 306 using one or more vectorization methods depending on the type and format of the data. For example, if the received attribute data includes a categorical variable, this categorical variable can be represented by one-hot encoding. If the received attribute data includes a sequential variable (e.g., a string), the sequential variable can be formatted using an n-gram (e.g., trigram) character-based long short-term memory (LSTM) model. If the received attribute data includes a spatial variable, the spatial variable can be modeled using a discretized input space, or mapped to a geographic region that is in turn represented by a categorical variable or a sequential variable. The categorical or sequential variable can then be vectorized using suitable methods (e.g., one-hot encoding or n-gram LSTM model processing).

Temporal data (and other types of attribute data) can be provided in, or transformed into, one or more variable types or formats. Example types include categorical variables, periodic variables, and sequential variables. Categorical variables can be vectorized by representing them using one-hot encoding. Sequential variables can be vectorized by representing them as a formatted string using an n-gram character-based LSTM model. Sequential variables can be vectorized by transforming the temporal data into one or more vectors respectively representing dimensions of the temporal data. Examples for each of these vectorization methods are provided herein.

The vectorized data is concatenated at 308 to provide a data input, e.g., a final input vector. Then, the concatenated data is input to the multilabel classifier at 310. The multilabel classifier provides an output with labels predicting one or more semantic tags for the POI, which output can be received at 312 by the processor 102 (internally or externally, depending on where the multilabel classifier is provided).

The multilabel classifier can include multiple binary models, where each binary model is specialized for predicting whether one label (e.g., semantic tag) is correct or not (that is, the relevance of the label in relation to the input), independently from the other labels, so that the predicted labels are the union of the predictions of all of these binary models. For example, if the predicted semantic tags are or include category labels for the POI taken from a label set stored in the database, the output of the multilabel classifier may be a probability score (e.g., provided by a probability vector) for each of the category labels in the label set. This probability score can be used by the processor 102 to select one or more of the predicted semantic tags, such as by selecting those that exceed a preset threshold.

The predicted semantic tags can be stored at 314 in a database such as the database 104 as additional attribute data of the POI. This additional attribute data can supplement and/or replace the observed semantic tags in the database for the POI. In this way, the predicted semantic tags are assigned to the POI, for instance to complete the set of semantic tags (although the method 300 can be performed again to update the set).

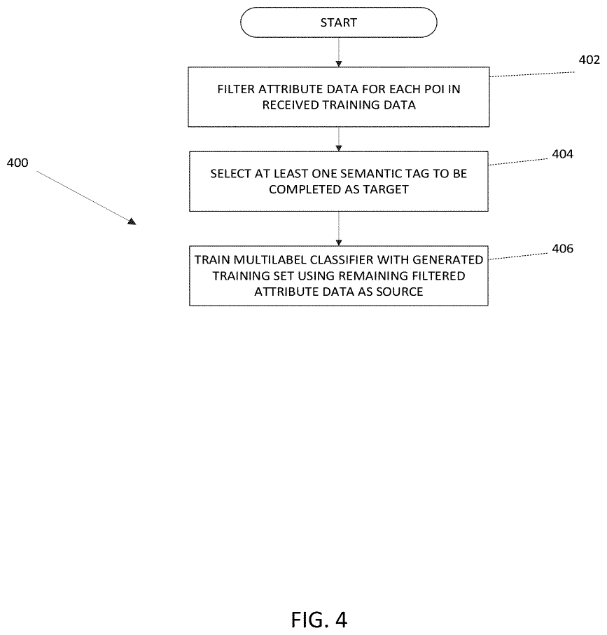

FIG. 4 shows an example method 400 for training the POI semantic tag prediction model (e.g., multilabel classifier). To provide a training set, the processor 102 optionally filters attribute data for each of a plurality of POIs at 402, e.g., as may be provided from a training set from a POI database. For example, the most representative (or relatively more representative) attributes for a POI semantic tag completion task may be selected from among a larger set of POI attribute data. Non-selected POI attribute data (e.g., aggregation meta-attributes, attributes with highly sparse values) can be ignored or removed. This filtering 402 reduces the search space during example training, which can allow the multilabel classifier to converge faster, and possibly improve precision and recall.

The POI attribute data after filtering includes temporal attribute data and metadata, although other data can be included as well. Example metadata after filtering can include, for instance, unique identifiers (as a nonlimiting example, an automatically generated string (e.g., “1983473649,” though strings are not limited to numerals) corresponding to a POI, which string is unique in the database) and names (e.g., POI names) that can be represented by one or more languages or scripts. For each of the plurality of POIs, the at least one semantic tag to be completed is selected as a target at 404, and the other attribute data (or a remainder of filtered attribute data after filtering 402) is vectorized to provide additional training data (e.g., a source) for the training set.

The multilabel classifier is then trained using the provided training set at 406. For example, the vectorized attribute data can be concatenated to provide an input vector that is input to the multilabel classifier for imputation. Parameters of the multilabel classifier are learned, for instance, by minimizing a binary entropy loss function.

### Example Embodiment: Automatic POI Category Completion Using Temporal Data

Example methods will now be described for processing POI data (e.g., restaurants and tourist spots) from a database provided by a global location-based search and discovery service (Foursquare). Points-of-Interest (POIs) in Foursquare's POI database can be described by a number of semantic tags, e.g., categories such as Falafel Restaurant, Bowling Alley, etc. In Foursquare, for instance, users select such tags from a hierarchical list of (currently) more than 900 categories. However, with LBSNs such as Foursquare, the POI databases are often crowdsourced, which makes the need for data curation significant.

Spatio-temporal data is an integral part of the Foursquare POI database, and such data is useful for predicting missing semantic tag values according to example methods. Experimental methods automatically propose categories for POIs (e.g., represented by POI data entities) based on the POI's existing stored attribute data including POI name, spatial metadata (location), and temporal metadata (opening hours), without accessing third party resources, such as an external corpus.

The recognition that POI categorization is a multi-label problem and that label sets are incomplete has implications on the influence of different inputs such as temporal data, and how these inputs should be represented. Example methods thus provide different ways to represent temporal information.

The example spatio-temporal data in the Foursquare database presents several unique characteristics, such as value periodicity in the case of time, and compound attributes in the case of space (e.g., geolocation is defined in terms of geo-coordinates such as latitude and longitude). Example methods account for such characteristics using one or more pre-processing steps. Data presented in multiple scripts and languages can be processed using example methods.

Experimental approaches for processing a large subset of a dataset from the Foursquare database led to good results. While POI names alone were shown to be fairly strong predictors of POI categories, the use of spatio-temporal data in example methods led to consistent improvements. Though not required in all methods, using a structured representation of time in the input data gave higher precision and required less computation time than string-based LSTM variants. Additionally, an LSTM model trained on semi-structured strings representing time was shown to be competitive to fully structured inputs in terms of recall.

Formal Statement of Categorization Problem

A goal of an example method is to complete POI categories. For instance, an example POI found in Foursquare's database is “ [symbol] [symbol] [symbol] ” (English translation: Traditional bougatsa place Badis) with opening times “6:30-15:00” and latitude/longitude “40.647039/22.938023”. The only category attributed to the POI in the existing database is Bougatsa Place. However, missing pertinent semantic tags may include, for instance, Breakfast Spot, Pastry Shop, and Snack Place. An objective is thus to automatically complete such missing tags.

An example method considers POI semantic tag completion as the problem of completing a specific attribute of the dataset, particularly the one that represents the POI's categories, based on data from the remaining attributes. Formally, a POI p should consist of an attribute that includes an ideal, complete, and correct category labelset, i.e., a set of relevant labels L⊂Λ, where Λ=l₁, . . . , lₘ is the set of all possible labels, and other attributes represented by the set A.

The set of labels attributed to each POI in the dataset, i.e., the observed labelset, is incomplete. So, if Lₒ represents the observed labelset, then Lₒ⊂Λ where Lₒ can be the empty set. For instance, revisiting the above example, the observed labelset Lₒ={Bougatsa Place} while L={Bougatsa Place, Breakfast Spot, Pastry Shop, Snack Place}.

One denotes by y=(y¹, . . . , y^{m}) an m-dimensional binary vector where yⁱ∈[0,1] such that yⁱ=1 if and only if lᵢ∈L. Accordingly, the m-dimensional binary vector yₒ=(yₒ¹, . . . , yₒ^{m}) with yⁱ∈[0,1] has yₒⁱ=1 if and only if lᵢ∈Lₒ. It is assumed that S∪T∪R=A, where S stands for the set of spatial attributes, T the set of the temporal ones, and R the rest of the attributes. Considering again the above example, the spatial attributes latitude and longitude would be instantiated by the corresponding values. The temporal attribute would include the opening times, while R is the name of the POI.

One denotes by x, x_{R}, x_{S}, x_{T} the vectors that represent correspondingly A, R, S, and T, such that the observed p in the dataset, is defined as p={x, yₒ}={x_{R}, x_{S}, x_{T}, yₒ} and one is trying to complete p such that p={x, y}.

This goal can be formulated as a multi-label classification problem where one wants to find a classifier h: X→Y where X is the input space (all possible attribute vectors) and Y the output space (all possible labelset vectors), such that y=h(x).

It is assumed in this example that the attribute containing opening times is included in x_{T} and the attribute with geospatial coordinates, e.g. latitude/longitude, in x_{S}. Opening times and geospatial coordinates should have non-null values. Optionally, x_{T} may also represent attributes describing the times that different services are available (e.g., in the case of restaurants, kitchen opening times may differ from bar opening times and/or happy hours).

Formal Representation of Data Curation Method

It is assumed that the observed categories of POIs, despite imperfect, can still be used to calculate relevant latent category semantics. To find h, an example method thus follows a standard approach and transforms the problem into finding a real-valued vector function ƒ:X→S that allows one to indicate the relevance of a label lᵢ in relation to the input, i.e., ƒ(x)=(ƒ(x, l₁), ƒ(x, l₂), . . . , ƒ(x, lₘ)) where ƒ(x, lᵢ) is the confidence of lᵢ∈Λ being a correct label for x and m is the number of labels. This actually corresponds to an estimation of p(yⁱ|x): yⁱ∈[0,1]. Note that ideally, observed outputs should be completely specified vectors. However, in the example context the training instances are only partially complete and correct, so of the form (xᵢ, yₒⁱ).

The example method follows the Binary Relevance method, thus learning m binary models, each specialized into predicting whether one label is correct or not, independently from the other labels. For an unseen x, the predicted labels are then the union of the predictions of all the binary models.

To learn the binary models the following general steps were executed:

Attribute selection: Some example methods followed a procedure in which the attribute to be completed is selected as the target and the rest of the attributes are used as training data. An example of this procedure is disclosed in Biessmann et al.

In other example methods, the attribute selection step was elaborated into selecting the attributes that are the most representative for the task (for instance, ignoring aggregation meta-attributes, such as total number of likes, and attributes with highly sparse values (e.g., Twitter ids)). This latter step can reduce the search space. In this way, the example model not only may converge faster but also may lead to slightly better precision and recall.

Vectorization: Example vectorization includes transforming the attributes in a form that can be treated by imputation models. In addition to the traditionally distinguished types of categorical and sequential data, other, specialized vectorizers can be provided for spatial and temporal data, provided in more detail below.

Imputation: The probability of lᵢ being a correct label given x is computed in this step. The example problem is casted as a supervised machine learning problem.

Further details of the vectorization and imputation steps will now be described.

Vectorization

Categorical variables: Categorical variables can be represented with one-hot encoded embeddings, using methods known by those of ordinary skill in the art.

Sequential variables: An example approach adopts character n-grams, particularly trigram character based LSTMs, to vectorize sequential variables. Character-based representations are more robust for sparse data and multiple languages, as can be input to example methods. Further, character n-grams have been shown to perform better than simple, unigram, character-based LSTMs.

Temporal variables: In the example POIs, the temporal variables described opening times. For instance, as a POI may offer several different services, different opening times for each service may be included in the data, e.g., kitchen opening times versus bar opening times.

Opening times represented recurrent intervals of time. While exceptionally they may vary over different seasons and/or specific periods of the year, such as Christmas, overall the opening times could be considered to exhibit periodicity.

Three alternative ways of representing and vectorizing opening times were used and compared in experimental methods:

As a categorical variable (bucket-based): This method included transforming the string into a one-hot vector according to the intervals during which the POI is open. For instance, if a POI opens every Monday at 9 am and closes at 9 pm, then if one decides the granularity of the intervals to be 3-hour ones daily, Monday would be represented with the following vector [0,0,0,1,1,1,1,0]. The granularity of the intervals can be chosen based on, for instance, a histogram of the values. An example method used ½-hour intervals for each day and concatenated them to represent all days of the week (where the week is repeated over the year). The concatenated vector was then used as input.

As a periodic variable: Opening time is periodic over two dimensions: 7-day week and 24 h day intervals. As disclosed in Bishop, 2006, such periodic quantities can conveniently be represented using an angular (polar) coordinate and as points of a circle. Consequently, to appropriately transform days, opening and closing times, two vectors can be created that hold the corresponding Cartesian coordinates.

For instance, if the vector that represents instances of day-time hours found in the training data is h, then each hⁱ∈h is transformed to two dimensions:

$${k}^{i} = sin ( 2 π \times \frac{{h}^{i}}{24} ) and {y}^{i} = cos ( 2 π \times \frac{{h}^{i}}{24} )$$

where kⁱ∈k and yⁱ∈y. Then one uses k, y as input vectors instead of h. Days and minutes can also be transformed in a similar manner.

As a sequential variable: As described above, time may be written as a formatted string, i.e., a semi-structured sequence of characters. Thus, another example vectorization method considers time as a sequential variable and uses the last state vector of a unigram-character based LSTM to represent the string value of the opening times. Additional details for this method are discussed below.

Spatial variables. Geographical coordinates are significant spatial attributes for characterizing a POI. For instance, latitude and longitude are two of the currently most frequently used geographical coordinates. An example method for modelling coordinates such as latitude/longitude discretizes the input space, e.g., as disclosed in P. Tsangaratos et al. and J. Zhang et al. This discretization can, for example, take the form of a grid separated into a fixed number of cells. The form and granularity of the cells can be selected appropriately. In a context of example methods, POI categories are usually country-specific (but can be city or region-specific).

The example method used in experiments mapped geo-coordinates to countries, though other geographic regions (cities, counties, states, territories, etc.) are possible. The corresponding data was then modeled as categorical variables. In such examples, the model may not learn geographical regions in a data-driven way. However, in other example methods, appropriate representations may be learned dynamically.

Imputation (Tao Completion)

Once the attributes were vectorized, a concatenation layer was used to combine them. Thus, if a is a POI attribute such that a∈A and ϕₐ(xₐ)∈ [symbol] ^{D}^{ₐ} is the attribute specific vectorisation function, where Dₐ denotes the dimensionality associated with the attribute a, then the final input vector is a concatenation of all vectorised individual attributes:

\acute{x}=[ϕ₁(a₁),ϕ₂(a₂), . . . ,ϕₙ(aₙ)]

where n denotes the number of attributes. This is fed to a dense layer:

h=relu[W^{h}\tilde{x}+b^{h}].

After applying a dropout layer, one then calculates

p(y|h},θ=sigmoid[Wh+b]

where θ=(W, b, W^{h}, b^{h}) are learned parameters of the model, and sigmoid(s) denotes the element-wise logistic function

$$f ( {s}_{i} ) = \frac{1}{1 + {e}^{{s}_{i}}} .$$

The parameters θ are learned by minimizing the binary cross-entropy loss function.

The example multi-label model outputs a probability score for each label. To obtain the corresponding set of labels from the probability score, a constant was applied as threshold, e.g., 0.5. If the output probability score is over the (e.g., pre-defined) threshold, then the corresponding predicted categories were used for imputation (tag completion).

Experimental Setup

Experiments were performed on ≈900K POIs extracted from a large database provided by Foursquare. The experimental dataset included 779 POI categories from the categorization hierarchy of Foursquare, as shown in Table 1 below.

As the example classification hierarchy was based on crowdsourced data, the parts of the dataset that included more POI instances were represented with more categories, resulting in it being heavily imbalanced. For instance, the most well developed category that was located at the root of the hierarchy was Food, with 336 categories distributed in five levels. The least developed one was Residence having only four subcategories, over two levels.

TABLE 1
Category Distribution in the dataset

| | | Categories |
|---|---|---|
| Root Category | Levels | in Path |
| Food | 5 | 336 |
| Shop & Service | 3 | 150 |
| Professional & Other Places | 3 | 74 |
| Outdoors & Recreation | 4 | 78 |
| Arts & Entertainment | 3 | 49 |
| Travel & Transport | 3 | 41 |
| College & University | 3 | 26 |
| Nightlife Spot | 3 | 25 |
| Event | 2 | 7 |
| Residence | 2 | 4 |

Semantic tag distribution. A sample dataset of POIs was extracted having spatio-temporal attributes from the existing Foursquare database. The most well-developed root category, Food, was used as a seed. The resulting dataset included about 900K POIs. The distribution of the categories was similar to the one found in the original hierarchy, as shown in Table 1 above. Note that even if Food was used as seed, the rest of the root categories in the dataset could be found. This is because POIs can be categorized using multiple labels, although at least one of the labels would have as seed Food.

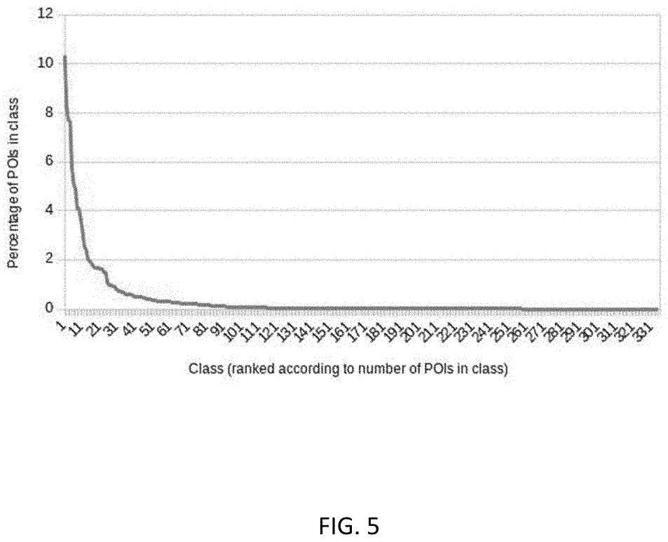

The label cardinality (i.e., average number of labels per POI) was 1.37, while the label density was 0.0018. These numbers further illustrate the complexity of the problem: the cardinality is relatively low due to incompleteness, while the density is also low, meaning there is a relatively high number of distinct labels. For illustration, the overall distribution of the semantic tags is shown in Table 2 and in FIG. 5.

TABLE 2

| Category | % tags |
|---|---|
| Fast Food Restaurant | 10.35% |
| Café | 8.28% |
| Pizza Place | 7.70% |
| Coffee Shop | 7.66% |
| Sandwich Place | 5.77% |
| Restaurant | 5.08% |
| American Restaurant | 4.91% |
| . . . | . . . |
| Ice Cream Shop | 2.03% |
| Breakfast Spot | 1.93% |
| . . . | . . . |
| Diner | 1.65% |
| . . . | . . . |
| Food | 0.24% |

It is apparent that the example dataset was skewed in terms of the POI instances attributed to each category, with the first ten top categories having more than half of the POIs attributed to them. The long queue of sparsely represented categories could also be an explanation of the low density.

The semantic tags attributed to the POI could be from different levels of the hierarchy. For instance the root category Food, the second level category Pizza Place, and the third level category Ice Cream Shop, were all included as semantic tags in the dataset. This illustrated that there was no constraint on the categories the user could input; i.e., they could come from any level of the hierarchy.

The hierarchy was also counter-intuitive at places. For instance, Restaurant and American Restaurant were siblings rather than having a hierarchical relation between them. This could be explained from the crowdsourced nature of the resource. A direct consequence was that similar POIs tended to be labelled differently from users, not only because all relevant labels may not be found by the user, but also because differences between categories may be fuzzy.

Further, it was observed that for some classes, spatio-temporal attributes should be more distinctive than others. For instance, it was expected that Breakfast Spots should open early and potentially be closed earlier than Bars, while Diners should be found more frequently in the US rather than in other countries.

The example POI attributes included the POI's name, its latitude and longitude, and its opening times, which were transformed into the different representations disclosed above. Contrary to some completely freely crowdsourced POI databases, the format of these example resources was normalized. Latitude and longitude were written in the standard form, normally with >10-decimal point precision (e.g., latitude: 55.76942424341726, longitude: 44.948036880105064). Opening times are represented in the form:

“day_1; opening_time_in_minutes_from_midnight_1;
closing_time_in_minutes_from_midnight_1|
day_2 ...”.

The days and the opening time intervals could have any order (e.g., day_2 (i.e., Tuesday) could be included before day_1 in the string representing the opening times). Although comments available for some of the POIs were not used for example experiments, it is possible to do so.

Multilinauality: Another significant characteristic of Foursquare's data is that it covers the entire globe, and as such it is highly multi-lingual. Conventional category completion methods have focused only on a couple of different languages, with each language represented in a separate dataset and thus potentially processed with appropriately tuned models (e.g. specific hyper-parameter tuning). In the case of POIs, however, it can be difficult to automatically create such separate datasets. For instance, POI string attributes, such as (but not limited to) their names, can be short, and thus automatic language identification techniques tend to be less accurate. Further, POI names tend to occasionally contain a mix of two or more different languages (e.g., Mr. Panino [symbol] ). Still further, POI names can be proper names in several cases (e.g., KiKi).

Example methods used character-based models, as explained above. Intuitively, character-based models tend to be more robust in highly multi-lingual settings than token (or word) based ones, although token or word-based models can be used in other example methods. In view of the deficiencies of automatic language identifiers for short strings (such as POI names), to quantify the number of different languages and alphabets included in the example dataset, as a proxy, the (relatively sparse) comments related to POIs were analyzed using the language identifier.

46 languages in total were detected, although 38.5% of the comments were written in English, and the top 10 most frequently used languages covered 76% of the comments. 9 different alphabets were also found, ranging from Russian to Chinese. The POIs found in the dataset came from 100 different countries.

To generate training and test data, approximate stratified sampling was used. The goal was to maintain the distribution of positive and negative examples of each label by considering each label independently. Consequently, the dataset of 890K POIs was allocated proportionally into 70% for training, 20% for development, and 10% for testing purposes. As the sets of labels attributed to each POI are incomplete, the dataset is a silver standard. All results were computed on test data that had not been used for training or validation purposes.

Evaluated Models

Several model variations were developed that corresponded to the different representations disclosed above. These were compared to a number of imputation methods known in the art.

BRknna, as disclosed in E. Spyromitros et al., is a Binary Relevance multi-label classifier based on k-nearest neighbors method. k is set to 1 based on the results of a grid search (k: {1,6]).

Datawig_hash is a method for data imputation with categorical data, as disclosed in Biessmann et al. This model encodes the value of POI attributes as hashed character n-grams. The example comparison closely followed the model hyperparameters, regularization and optimization techniques disclosed in Biessmann et al., with only small changes to allow multi-label imputation instead of single-label imputation. This included using the sigmoid logistic function instead of softmax at the output layer and applying the same threshold as for the example model (0.5) to select which predictions to keep.

Datawig_LSTM is a Unigram-character based LSTM model of the method introduced in Biessmann et al. Again, the example comparison closely followed the model hyper-parameters, regularization, and optimization techniques disclosed in Biessmann et al., only introducing small changes to allow multi-label imputation instead of single-label imputation. This included using the sigmoid logistic function instead of softmax at the output layer and applying the same threshold as for the example model (0.5) to select which predictions to keep.

For the experimental model implementations, the input variations included: Base (POI names as trigram-character based LSTMs; when used alone, it is considered as a baseline for the rest of the example models); t_sincos (temporal information was implemented as a periodic variable); t_30 (temporal information as one hot vector based on intervals of 30 min (buckets)); t_LSTM (Temporal information represented as a sequence (unigram-character LSTMs)) and s_geo (geo-coordinates as vectors representing corresponding countries).

For each model variation, a neural network architecture was used with one hidden dense layer, followed by a dropout layer, and the output layer. The Rectified Linear Unit (relu) was used as the activation function of the hidden layer. The dropout rate was set to 0.3. The loss used was binary cross-entropy. An early stopping criterion for the training was set based on a pre-defined threshold that takes into account the delta of the loss between two consecutive epochs. For all sequential features a length of 50 was applied. For the LSTM layer the dimensions of the embedding layer vector space were set to 128, and the number of the LSTM hidden units was set to 128. The LSTM had a recurrent dropout rate of 0.3.

Experiments were run on a single GPU instance (1 GPU with 16 GB VRAM, 4 CPUs, with 256 GB RAM). Training was performed with a batch size of 32. The Adam optimizer was used with default parameters as disclosed in D. Kingma et al.

Silver Standard Evaluation

All results below are on the test dataset, which was not used for training or validation purposes. For each model the average micro precision, micro recall, and micro F1 were calculated, excluding outlier values, over ten runs (except that datawig_LSTM was averaged over 3 runs). Outliers were values that fall below Q1−1.5*IQR or above Q3*IQR, where IQR is the interquartile range and Q1 and Q3 are the first and third quartiles. The results are shown in Table 3.

TABLE 3
Average performance (%) over 10 runs (except for BBknna). Best results
are in bold. Standard deviation is reported in brackets.

| Model | Micro-prec. | Micro-rec. | Micro-F1 |
|---|---|---|---|
| BRknna | 41.35 | 39.90 | 40.61 |
| Datawig_hash | 74.89 (±0.63) | 35.59 (±0.68) | 48.24 (±0.50) |
| Datawig_LSTM | 69.10 (±0.59) | 37.77 (±0.62) | 48.84 (±0.54) |
| Base | 72.55 (±0.54) | 38.60 (±0.8) | 50.38 (±0.63) |
| +s_geo | 72.96 (±0.5) | 40.06 (±0.64) | 51.72 (±0.61) |
| +t_LSTM | 72.62 (±0.47) | 39.81 (±0.64) | 51.42 (±0.56) |
| +t_30 | 74.96 (±0.8) | 36.50 (±0.71) | 49.10 (±0.58) |
| +t_sincos | 74.20 (±0.51) | 38.38 (±0.54) | 50.60 (±0.47) |
| +s_geo+t_LSTM | 73.56 (±0.35) | 41.61 (±0.4) | 53.15 (±0.38) |
| +s_geo+t_30 | 74.96 (±0.72) | 37.38 (±0.98) | 49.88 (±0.80) |
| +s_geo+t_sincos | 74.61 (±0.34) | 39.50 (±0.56) | 51.65 (±0.48) |

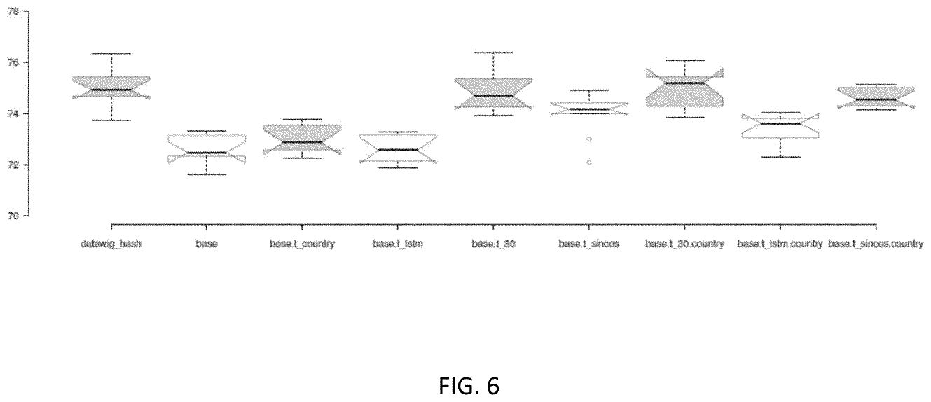

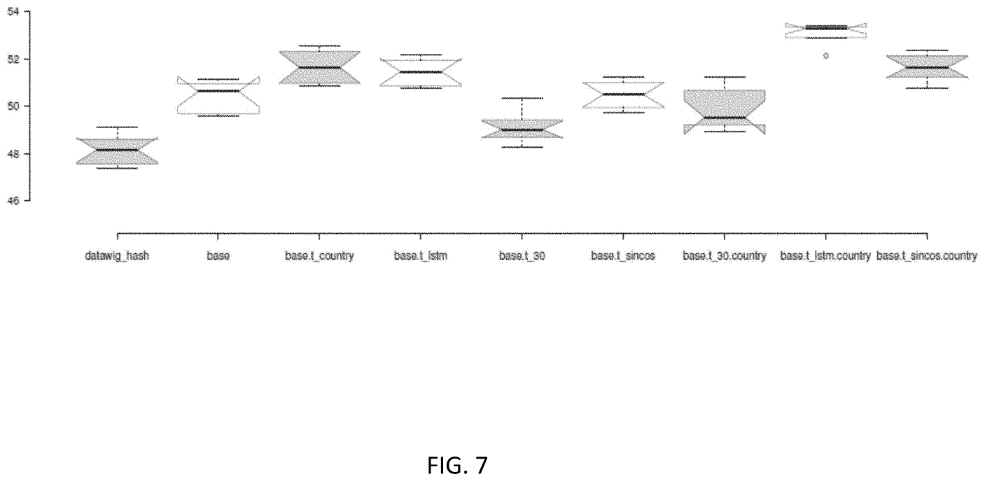

To further illustrate the significance of the results, corresponding boxplots were also generated using BoxPlotR. The precision scores are shown in FIG. 6 and the F1 scores are shown in FIG. 7.

Baseline: The example baseline predicted POI categories with 72.55% precision and 50.38% F1 scores. The micro-F1 was also higher than current state-of-the-art methods, which indicates that the POI name is a strong predictor of the category, and that vectorizing appropriately the name and optimizing the model accordingly is useful.

Appropriate addition of spatio-temporal information resulted in models with higher micro-precision and micro-F1 scores. The difference between the baseline and the models including spatio-temporal information was consistent. The average difference in terms of F1-score between the baseline and the best performing model was 2.7 absolute percentage points in micro-F1 and 2.4 points in micro-precision. Over the hundreds of millions of POIs included in the database of Foursquare these differences were significant.

The impact on the results from the addition of each type of information will now be discussed.

Spatial data: Table 4 shows the categories in which the differences were most significant compared to the baseline model. The results for the addition of the spatial data showed that categories with limited training data and strongly correlated to the location of the POI were mainly included. Examples include Australian Restaurant and Brasserie (a POI type found mainly in France and the Francophone world). One category of note is Pet Café: in that case the example model learned that Cafés and Tea Shops in Japan that have the character [symbol] (meaning ‘cat’) in the name are probably categorized as Pet Cafés (the baseline favors Café instead).

Although spatial data had a positive impact in general, in terms of micro scores the categories that were improved were mainly part of the long tail. In useful application, though, this is significant, as long tail categories are rarer and thus even more difficult to find in an explicit search.

TABLE 4
Top 10 categories in terms of performance difference to
the baseline (the delta in precision is in brackets)

| s_geo | t_30 | s_geo+t_30 |
|---|---|---|
| Australian Restaurant | Portuguese Restaurant | Tex-Mex Restaurant |
| (0.85) | (0.38) | (0.41) |
| Pet Café (0.77) | Fish & Chips Shop | Diner (0.26) |
| | (0.31) | |
| Trattoria/Osteria | Bubble Tea Shop | Taco Place (0.25) |
| (0.66) | (0.26) | |
| Hong Kong Restaurant | Taco Place (0.24) | Italian Restaurant |
| (0.61) | | (0.23) |
| Austrian Restaurant | Friterie (0.16) | Wings Joint (0.17) |
| (0.58) | | |
| Brasserie (0.55) | Convenience Store | Thai Restaurant |
| | (0.11) | (0.14) |
| Mongolian Restaurant | Noodle House (0.10) | Snack Place (0.13) |
| (0.54) | | |
| Cha Chaan Teng (0.45) | Chinese Restaurant | Sandwich Place |
| | (0.09) | (0.12) |
| Tex-Mex Restaurant | Grocery Store | Bakery (0.11) |
| (0.43) | (0.08) | |
| Unagi Restaurant | Bar (0.07) | Convenience Store |
| (0.39) | | (0.11) |

Temporal Data: For the example temporal model there were performance differences that intuitively made sense. For instance, the opening times of Convenience Stores, Grocery Stores, and Bars may have been presumed to be particularly different compared to restaurants. However, other gains were more surprising, such as the category Portuguese Restaurant.

Analyzing the predictions, it was seen that the example baseline occasionally had problems with predictions such as “Nando's Mall of the North,” even though Nando's is a well-known Portuguese chain of restaurants with thousands of occurrences in the database (this happened especially when the name of the POI includes many characters). The regularity in the opening times though (i.e., 11:00-21:00 on weekdays and 09:00-23:00 on Friday and Saturday) seemed to help the corresponding example model to be more confident and generate a correct prediction.

In other cases, the POI name indicated that it should be a Portuguese Restaurant, but the opening times did not fit the corresponding distribution. For instance, Mando's, a Mexican Restaurant, was predicted as a Portuguese Restaurant by the baseline because of the obvious similarity of the name to Nando's. However, the POI is open daily 09:00-02:00. In that case, the t_30 model did not generate any predictions and thus no false positives.

These examples were representative of the way in which the addition of temporal information also helped with the rest of the POI categories.

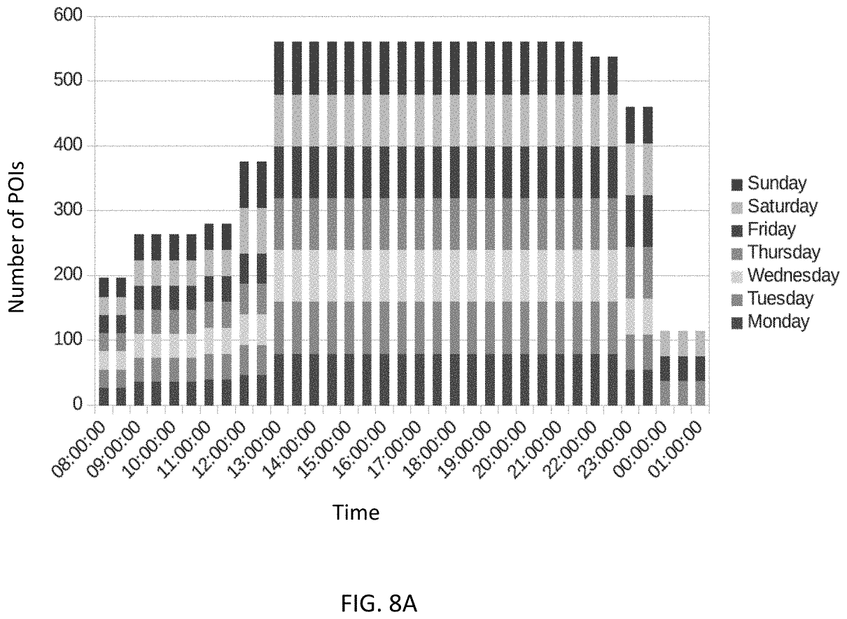

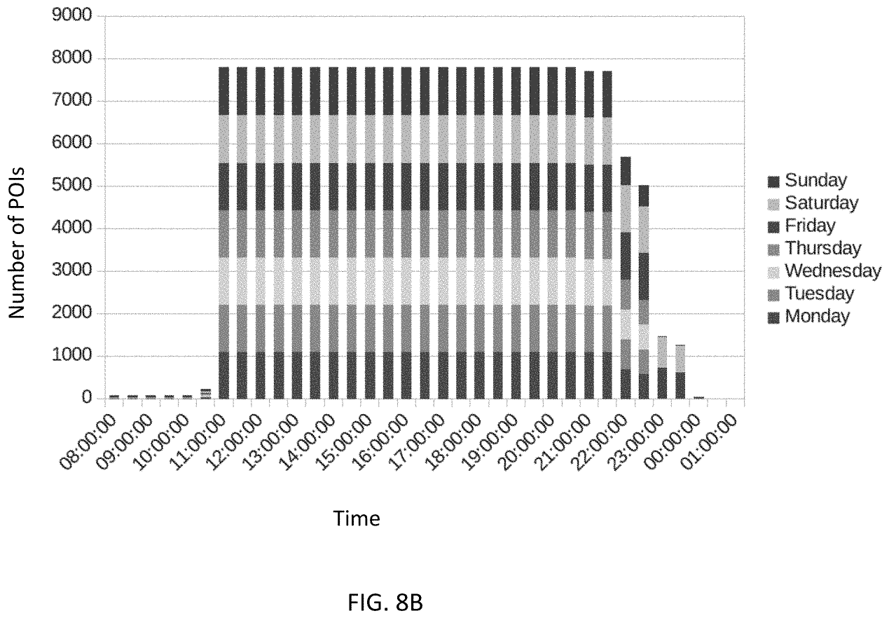

Combining spatial and temporal data: POI categories in this case had a strong geo-spatial character, constrained to a few countries, and in addition opening times differed among these countries. For instance, Tex-Mex Restaurant gained 0.21 points of micro-precision with the addition of the spatial data because a large percentage of these restaurants is found in the US and Mexico compared to other countries. As shown in FIGS. 8A and 8B, the distribution of opening times was different between the two countries Mexico and the US, respectively, and helped to further improve the predictions. For instance, Tex-Mex restaurants in the US had a quite regular opening times pattern, starting service at 11:00 and closing between 22:00 and 23:00 in the evening, with the exception of Friday and Saturday when they close later as shown in FIG. 8B. In Mexico, the range of opening times was larger as shown in FIG. 8A. In addition, restaurants closed later not only on Friday and Saturday, but also on Thursday evenings.

Impact of different time representations: The best micro-precision among the example model variants was given by the model that used the structured representation of time, i.e., the one based on 30-minute intervals. On the other hand, the best micro-F1 was given by the model that used a combination of the spatial data with the LSTM-based representation of time. This sounds counter-intuitive, as the structured representations should include richer information compared to the LSTM variant, which only processed the corresponding semi-structured text.

One example POI category useful in appreciating this difference is Breakfastspot. This category's semantics intuitively should be related to places that open early enough to offer breakfast. The predictions of the t_lstm model seemed to favor places that have early opening times (ones that start with the characters ‘3’ or ‘4’; in Foursquare time is measured in terms of minutes from midnight, so “300-480” corresponds to 06:00-08:00). The structured representation seemed to further allow instances that open at 08:30 (i.e., “510” in Foursquare's representation), capturing the fact that “480” is close to “510” in this case. On the other hand, t_30 did not favor Breakfast Spot predictions when the corresponding POIs closed late, i.e., after 16:00. The LSTM model was much more tolerant on closing times, and thus achieving higher recall, while the structured representation favored micro-precision.

Computation Time

The baseline (name-only) model took 27 hours and 33 epochs to converge. The base+s_geo+t_30 model took less time, with 24.5 hours and only 19 epochs, while the base+s_geo+t_LSTM variant required the most computation time, 73 hours and 39 epochs. This is a significant difference, especially in a production-oriented scenario where models are regularly updated.

### EVALUATION

While the improvements obtained on the silver standard were significant, it is noted that the labels (i.e., semantic tags) attributed to each POI were incomplete. This could lead to the precision being incorrectly penalized in the evaluation, as values predicted by the example model were counted as incorrect even if they were correct but absent from the test data due to incompleteness. In this sense the micro-precision values presented were a worst-case scenario while the micro-recall ones may be optimistic.

To understand the potential impact of an example method on the current database, a small sample of 163 POIs was used for additional evaluation, manually annotated for completion. Label cardinality in this sample was 2.8 instead of 1.37 in the silver standard. There are several reasons for this difference: in some cases, it was clear that labels were missing; e.g., McDonald's was labelled as a FastFoodRestaurant but not a Burger Joint, and Au Bon Pain was labeled as a Café but not as a Bakery.

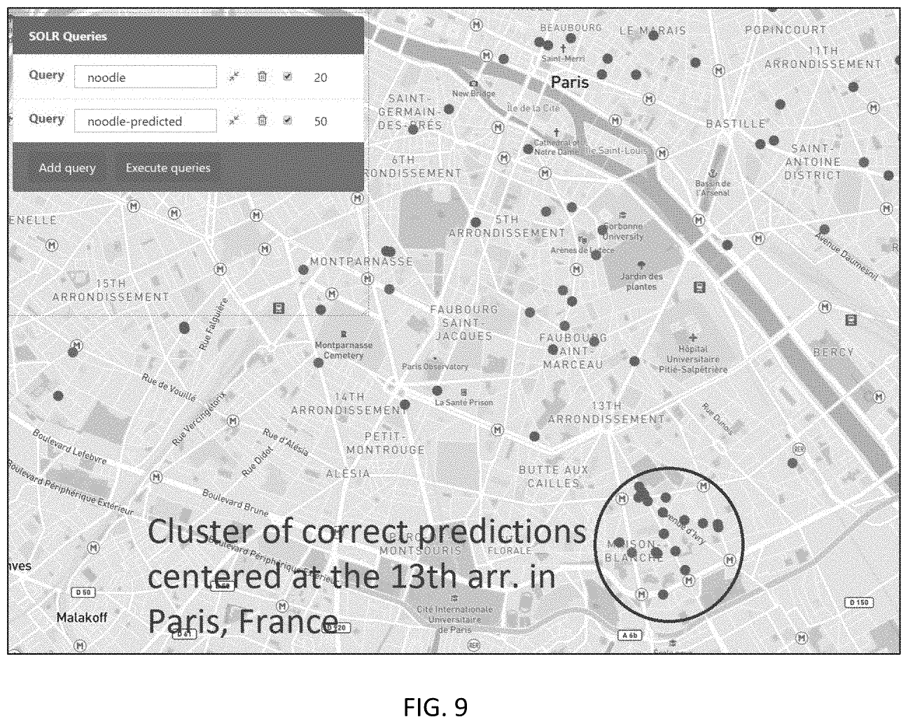

This is plainly illustrated in FIG. 9, which shows the results of a search, using Foursquare's data, for POIs with the semantic tag Noodle House in a small part of Paris. The database included 20 results, while 50 additional Noodle Houses were predicted. Those results were counted as incorrect in the example evaluation. However, it can be seen that the predictions clearly designated the 13th arrondissement, an area with a lot of Asian Restaurants, as having several noodle houses (the database included only a couple), which appeared reasonable. Looking closer at the results, it can be seen that the predictions were actually correct: La Table du Ramen was labelled as a Chinese Restaurant by users, while Ramen is a Japanese dish based on noodles. Pho Bida Vietnam was labelled as a Vietnamese Restaurant, however, Pho is a Vietnamese noodle soup, so the prediction seems to be more precise than the existing label.

However, there are also cases that were difficult to judge even for a human, as some categories are inherently fuzzy. For instance, Dunkin' Donuts has been labelled as a Donut Place, but may or may not be properly labeled a Snack Place or a Fast Food Restaurant. In addition, semantics between seemingly distinct labels appeared to vary according to the country. For instance, in the majority of countries, Starbucks was categorized as a Coffee Shop, but in Brazil half of the instances were also tagged Café. This illustrates the difficulty of creating a gold standard.

In view of this difficulty, retrospective evaluations were also performed. In these evaluations the output of the approach was given to human judges for annotation, who then labeled completions or flagged errors as correct and incorrect. The metric in this case was usually precision combined with the total number of completions or errors found.

The best performing example model, Base+s_geo+t_LSTM, was evaluated in this manner on 100 POIs that were marked as errors in the silver standard evaluation. In the case of multiple predicted labels, if all labels were correct then the whole prediction was considered correct. In the case that m out of n predicted labels were correct a score was calculated that corresponded to the m/n ratio. Results are shown in Table 5. Projected completions accounted for more than 7% of the number of labels; i.e., 11900 additional labels, at a projected micro-precision reaching ≈86%.

TABLE 5

| | No. of predictions | | | Projected no. of |
|---|---|---|---|---|
| | marked as errors | | | correctly added |
| | in the silver | | | labels in the |
| | standard evaluation | | Projected | current test |
| | that are actually | Total no. of | micro-prec. | set (Original |
| Model | correct | predictions | (silver) | no. of labels) |
| Base + s_geo + t_LSTM | 47/100 | 87999 | 0.8592 (0.7356) | ≈11900 (151K) |

Additionally, in the experimental silver-standard evaluation, a strict approach was taken; i.e., the label needed to be exactly the same as in the ground truth to be correct. However, in some cases the example model predicted categories that were one level higher in the POI category hierarchy of Foursquare. For instance, a prediction would be Bar while in the ground truth the label was Cocktail Bar or Sports Bar. In these cases the error is not potentially as important as, say, predicting Bakery while the correct category is Japanese Restaurant.

Such cases were analyzed in the example retrospective evaluation. Out of the 100 silver standard errors, 7 were due to generalization and 8 due to label specialization (e.g., Empanada Restaurant was predicted instead of Mexican Restaurant), while 3 of them were errors in the silver standard. Error importance can be added to account for such differences.

Automatic POI Category Completion Using Culture-Aware Data

Additional example methods provided herein consider culture, represented by one or more items of data, as a contextual parameter to assist with generating semantic tags for POIs. “Culture” or “cultural” as used herein broadly refers to one or more identifiable characteristics (e.g., locations, backgrounds, beliefs, languages, religions, behaviors, forms, traits, etc.) of members of a particular social group or environment that can be distinguished from analogous characteristics of members of a different social group or environment. In some example methods, social groups or environments can be classified by a geographic region, such as but not limited to a country, where a member resides, has a nationality or citizenship, or is domiciled (e.g., a location where an entity resides or has resided, or a location with which that entity identifies as a permanent home or otherwise has a substantial connection; e.g., the member's nationality, citizenship, or cultural background). “Culture-aware” or “culture-related” data as used herein thus refers to data that represents one or more of these identifiable characteristics.

Some existing systems provide context for POI categorization in terms of location generally. However, it has been recognized that cultural aspects in particular influence the categorizations of POIs. For instance, in a recommender system, the cultural background of a user can play a significant role in how recommended items are judged. It has been found that integrating information about cultural backgrounds, for instance in a global setting, can assist with developing high quality categorization systems. Particular example methods herein allow a processor-implemented model to predict semantic tags, such as POI categories, for POIs by taking into account cultural aspects.

Additionally, as with example methods disclosed herein that incorporate temporal (or spatio-temporal) POI attribute data as an input to a prediction model, example methods can consider culture-aware data as context without requiring access to user information such as check-in data. However, as with other embodiments, such information can also be used if desired.

Some example methods simulate user information during training of a POI semantic tag prediction model by providing proxy information as culture-related training inputs, and then at inference time replacing these culture-related training inputs with corresponding culture-related information for a user in an appropriate manner. For instance, the country (or other geographic region) where a POI is located can be provided as one of the training inputs for a POI semantic tag completion model. Then at inference time, the values of this input can be replaced with the nationality of a user requesting POI information. Such methods offer the further advantage that computation for training the POI semantic tag prediction model can be done offline.

POI semantic tags provided using example methods have utility in various applications, such as but not limited to information search and automatic recommendation. For example, a user may not be familiar with local culture to discover appropriate POIs in the vicinity of her/his position. If POIs are not categorized appropriately, the user cannot easily search for them, and they will not be included in the search results. Generating POI categories by taking into account culture-aware data can thus provide improved results for users.

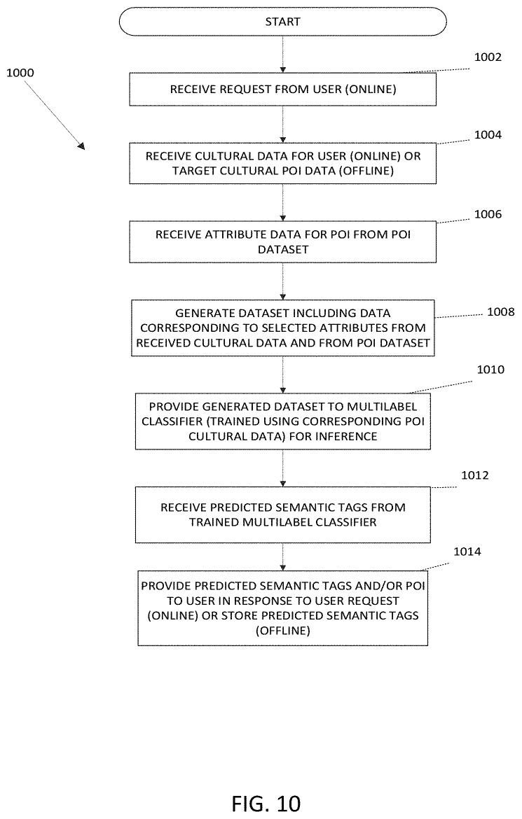

FIG. 10 shows an example method 1000 for automatically assigning semantic tags to a POI using culture-aware data. The method 1000 may be performed, e.g., by the processor 102. The POI is represented by attribute data, e.g., as stored in a data storage such as database 104. Predicted semantic tags can include, for instance, category labels for the POI, taken from a label set stored in the data storage.

If the assignment of semantic tags is in response to a user request from an online user, the request can be received at 1002 from the user, such as via the user terminal 106a, 106b. The request can be, for instance, a search request for one or more POIs including the POI, a proposed semantic tag for the POI, or other request. If the assignment of semantic tags is being performed offline, such as to complete a POI database, this receiving 1002 can be omitted

Cultural data is received at 1004. If the semantic assignment is in response to an online user request, the cultural data can include, for instance, culture-related user attributes (or user properties) such as but not limited to a users nationality, background, etc., or any combination, indicated by a users home or background geographic region (e.g., country), language, etc. or combination. This cultural data can be received directly from the user as part of or with the request, or retrieved from other sources, e.g., by accessing user data that includes the cultural data. As the processor 102 is online (to receive the user request), this receiving step 1004 also may be performed online to access user data. A users privacy can be respected since the information can reside on the user terminal 106a, 106b (that is, it need not reside on the database 104 or on an external corpus to be used in example methods).

Alternatively, if the semantic assignment is not in response to an online user request (e.g., if semantic assignment is being performed offline to complete a POI database), the cultural data can include culture-related target POI attributes. Culture-related target POI attributes include, for instance, a target POI's geographic region (e.g., country), language, etc. or combination. These attributes allow an example inference method to simulate different cultures offline for supplementing POI semantic tags to complete a POI database.

In response to the request, attribute data for the POI is received at 1006, e.g., from a POI dataset. For instance, if the user request is a search request for one or more POIs, the processor 102 may search for and retrieve the POI in response to the search request. If semantic assignment is being performed offline, the processor 102 may search for and retrieve a POI selected from an automated (e.g., iterative) selection. This attribute data can represent culture-independent POI properties, such as POI names, metadata, etc., examples of which are provided elsewhere herein.

The processor 102 then generates a dataset at 1008 including data corresponding to a selected set of attributes from the received culture-related data and the received (culture-independent) attribute data for the POI. The selected set of attributes includes culture independent POI attributes, such as a POI name or other attributes, as well as at least one cultural attribute that is generated from the received cultural data. The generating 1008 can include vectorizing the data corresponding to the selected set of attributes, concatenating the vectorized data, and inputting the concatenated data to the multilabel classifier, using methods disclosed elsewhere herein.

The generated dataset is provided to a multilabel classifier including a neural network model at 1010. This multilabel classifier is previously trained for predicting one or more semantic tags for each of a plurality of POIs using a plurality of training sets.

Each of the training sets used during this training includes a set of attributes including culture-related POI attributes and culture-independent POI attributes, which can be provided, e.g., from received attribute data from the data store. Culture-related POI attributes (i.e., cultural attributes) can include, for instance, a geographic location (e.g., a geographic region, such as a country) for the POI, languages associated with the geographic location, opening hours, a price range of corresponding services, or other cultural attributes concerning the POI.

Further, the sets of attributes in the training set correspond to the selected sets of culture-related and culture-independent attributes in the generated dataset that is provided to the multilabel classifier during step 1010. In other words, the set of selected culture-related user attributes used for online inference (including their values) is a subset (e.g., up to and including the entire set) of the set of culture-related POI attributes used for training, and the set of culture-independent POI attributes used for inference is analogous to the set of culture-independent POI attributes used for training. Similarly, the set of culture-related target POI attributes used for offline inference is a subset of the set of culture-related POI properties used during training.

However, the culture-related attributes in the training set are generated using culture-related POI properties, while the culture-related attributes in the selected dataset for online inference are user attributes generated from received user data (e.g., when available online). The culture-related POI attributes used during training thus simulate culture-related information so that user-specific information need not be used. For offline inference (e.g., offline POI semantic tag completion), culture-related target POI attributes can be used to simulate various user cultures, which again avoids the need to use user-specific information. Thus, in training or offline inference, culture-related POI properties can be used to simulate different cultures, without accessing user data.

The (trained) multilabel classifier, having been provided the generated dataset, provides an output including one or more semantic tags for the POI, which is received by the processor at 1012. The provided one or more semantic tags can then be provided to the user at 1014, e.g., via the user terminal 106a, 106b. For instance, a visualization of the one or more related semantic tags (e.g., POI categories) can be generated for display on a display of the user terminal 106a, 106b. If the user request includes a proposed semantic tag, the processor 102 can provide additional or alternative semantic tags to the user, e.g., using a visualization generated for display on the display of the user terminal 106a, 106b.

As another example, if the user request is a search request for POIs having a particular POI category, the processor 102 may provide a retrieved POI that has a predicted POI category matching the requested POI category, or related to the requested POI category in a hierarchy (e.g., a subcategory or super-category) by comparing the predicted semantic tags for the one or more retrieved POIs to the one or more categories provided in the search request.

In the offline method for automatically assigning one or more semantic tags to a POI, the (automatically) predicted POI semantic tags, or a selected subset thereof, can be stored in the data store (e.g., the database 104). This offline method can be performed to supplement the data store or for other purposes, without accessing user data.

Example Embodiment: Automatic POI Category Completion Using Culture-Aware Data

Formal Problem Definition

A goal of an example method is to predict POI categories (or other semantic tags) that are appropriate to a specific culture. For instance, a typical place found in Foursquare's database is “La Table du Ramen” (English translation: “The Table of Ramen”), which is located in Paris, France. The category found in the database is Japanese Restaurant, which may be sufficient for the local culture. However, a Japanese person would expect the POI to be categorised at a much more fine-grained level, for instance as Ramen Restaurant or as a Noodle House. Thus, an objective of example methods is to automatically predict such categories according to one's culture (e.g., a user's culture).

Similar to the example methods described above that consider temporal or spatio-temporal data, it is considered that POI category prediction in this context is equivalent to the problem of completing a specific attribute of the dataset, the one that represents categories of POIs, based on data from the remaining attributes. Formally, a POI p should have an attribute that includes an ideal, complete and correct, category labelset, i.e., a set of relevant labels L⊂Λ, where Λ=l₁, . . . , lₘ is the set of all possible labels, while the rest of the attributes are represented by the set A. Again, in practice, the set of labels attributed to p, what one calls thereof the observed labelset Lₒ⊂Λ, can be incomplete and/or incorrect.

In example culture-aware methods, it is further assumed that there are several “culture specific” label sets, such that ∪ⱼ₌₁ⁿ Lⱼ⊆L, where n is the maximum number of cultures that are represented by the labels in A and n<∞. For instance, revisiting the above example, if it is assumed that L={Japanese Restaurant, Noodle House, Ramen Restaurant}, and one has at least two cultures, French and Japanese, with corresponding labelsets L₁ and L₂, then it could be that L₁={Japanese Restaurant, Noodle House} and L₂={Noodle House, Ramen Restaurant}, while Lₒ={Japanese Restaurant}.

One denotes by y=(y¹, . . . , y^{m}) an m-dimensional binary vector where yⁱ∈[0,1] such that yⁱ=1 if and only if lᵢ∈L. A variant of it is defined for culture c as y_{c}=(y_{c}¹, . . . , y_{c}^{m}) where y_{c}ⁱ∈[0,1] such that y_{c}ⁱ=1 if and only if lᵢ∈L_{c} and each yⁱ−y_{c}ⁱ is non-negative. Accordingly, the m-dimensional binary vector yₒ=(yₒ¹, . . . , yₒ^{m}) with yⁱ∈[0,1] has yₒⁱ=1 if and only if lᵢ∈Lₒ.

It is assumed that C∪N=A, where C stands for the set of culture-related attributes, and N the set of culture-independent ones. Considering again the above example, the culture-related attribute C could be instantiated by the country where the restaurant is located, and the culture-independent attribute N by the name “La Table du Ramen”.

One can then denote by x, x_{C}, x_{N} the vectors that correspondingly represent A, C, and N, such that the observed p in the dataset is defined as

p={x,yₒ}={x_{C},x_{N},yₒ}

The objective is to make culture-specific predictions such that for culture c

p={x,y_{c}}

The goal is thus formulated as a multi-label classification problem where one wants to find a classifier b_{c}: X→Y where X is the input space (all possible attribute vectors) and Y the output space (all possible labelset vectors), such that y_{c}=b_{c}(x).

Example Category Prediction Method

The category of POIs, especially in a location-based social network, is related to the cultural profile of the users that visit it. Thus, some known methods for categorizing POIs have employed user information from user profiles. However, instead of accessing user information to discover such profiles, example methods herein use the observation that the majority of POIs are categorized in a manner that reflects local culture in location-based social network databases.

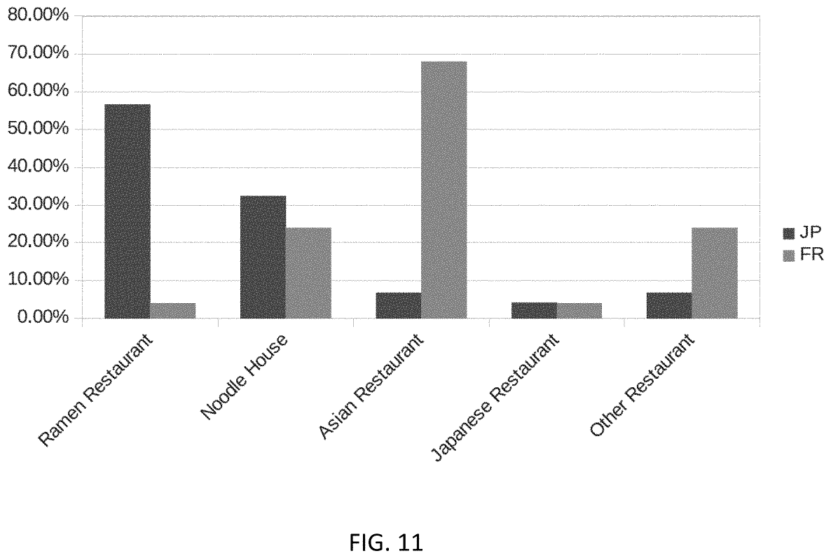

For instance, FIG. 11 shows percentages of category labels related to the token “noodle” in Japan and France from the Foursquare database. The figure illustrates that in this database restaurants selling noodle dishes (the token “noodle” is explicitly mentioned in the POI name) are usually categorized as Asian Restaurant in France, while Ramen Restaurant is by a large margin the most popular category in Japan.

Based on this insight, if at training time an example method uses culture related attributes to learn a latent representation of a POI's categories, then at inference time the corresponding inputs can be replaced according to the target cultural profile. For instance, if at training time one uses the country (or other geographical region) in which the POI is located as an input parameter to an example model, then at inference time one can replace the value of this parameter with the target country (or target geographical region), simulating what would happen if the same POI was located in the target country instead. In this way it is possible to generate culturally appropriate predictions and complete the database offline.

Revisiting the above example, it can be assumed that some of the Ramen restaurants located in Japan would be categorized in a different manner, e.g., as Noodle House, if the value of the country was changed to France.

In an example category prediction method, the above problem can be reformulated to look for a classifier b_{c} such that y_{c}=b_{c}(x_{c}) where x_{c} is a culture-specific variant of the input. To find b_{c}, an example method transforms the problem into one of finding a real-valued vector function ƒ:X→S∈[0,1]^{m} that allows one to indicate the relevance of a label lᵢ in relation to the input; i.e., ƒ(x_{c})=(ƒ(x_{c}, l₁), ƒ(x_{c}, l₂), . . . , ƒ(x_{c}, lₘ)) where ƒ(x_{c}, lᵢ) is the confidence of lᵢ∈Λ being a correct label for x_{c} and m is the number of labels. This corresponds to an estimation of p(y_{c}ⁱ|x_{c}): y_{c}ⁱ∈[0,1]. Ideally, observed outputs should be completely specified vectors, however in a context where the training instances are only partially complete, the observed outputs can be of the form (x_{c}ⁱ, yₒⁱ).

As in the example temporal-based methods, example culture-aware POI category completion methods follow the Binary Relevance method, learning m binary models, each specialised into predicting whether one label is correct or not, independently from the other labels. For an unseen x_{c}, the predicted labels are then the union of the predictions of all the binary models.

To learn the binary models the example method follows the steps described above for example temporal-based methods, with a difference being that at the inference step the inputs are changed corresponding to cultural parameters. Example methods thus can include attribute selection, vectorization, training, and inference.

In an example attribute selection, the name and spatial geo-coordinates of the POIs are provided. Example vectorization includes transforming the attributes in a form that can be treated by the classifier. In example methods, in addition to conventionally distinguished types of categorical and sequential data, vectorizers are also used for the spatial data as explained above with respect to the example temporal data-based methods. In example training, a model is computed that learns to predict the probability of lᵢ being a correct label given x. As with the temporal data-based methods, this problem can be casted as a supervised machine learning problem.

Then, an example inference computes whether lᵢ is a correct label for culture-specific variants of x.

Vectorization

Example vectorization methods will now be described in more detail. In an example vectorization, categorical variables can be represented with one-hot encoded embeddings, as provided above. For sequential variables, character based LSTMs can be used, as further provided above.

Cultural variables in example methods can include spatial variables and, optionally, other cultural variables. For spatial variables, example methods may use countries as a proxy of different cultures. Countries can be represented, for instance, as categorical variables, as this granularity can be related to different cultures, as explained above. However, other representations could also be suitable, such as geographical regions, etc.

Other cultural variables may be provided in one or more additional category that include other parameters related to culture. For instance, for determining socio-cultural context, opening hours and the price range of corresponding services may also be important. An example vectorization of opening hours is discussed above. Price ranges, as another example, can be discretized using methods such as those described above, and considered categorical variables.

POI Categorization Model Training

Once the attributes are vectorized, a concatenation layer can be used to combine them, and the concatenated input vector can be fed to layers. Example methods for concatenating vectorized attributes and training using the concatenated final input vector can be the same or similar to those described above for the example temporal data-based POI completion methods.

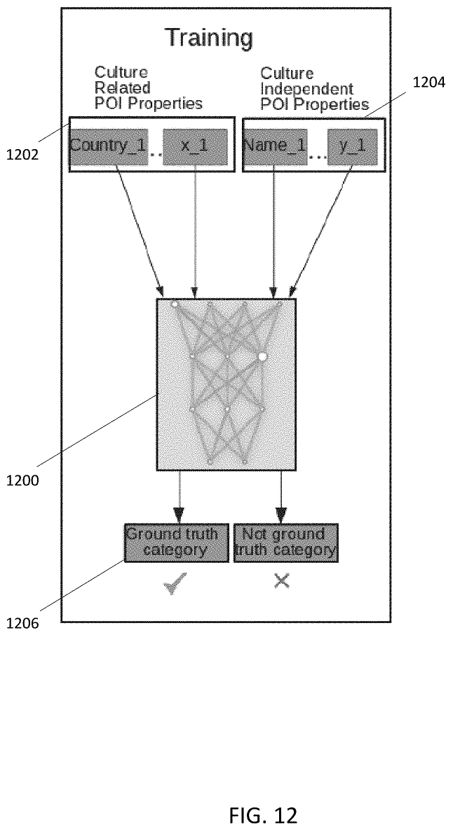

FIG. 12 shows a flow of data in an example method for training a neural network based POI categorization model 1200, which is a multilabel classifier. To train the (untrained) neural network model 1200, a set of culture-related POI properties 1202, (e.g., Country_1, . . . x_1, where Country_1 is the country in which the POI is located) and a set of culture-independent POI properties 1204 (e.g., Name_1, . . . , y_1) are input to the model, for instance by their concatenation in the input vector. The neural network model 1200 outputs a predicted POI semantic tag, which in this example is a POI category, and the result is compared to a ground truth category 1206. The result of this determination is used to update parameters in the model 1200.

Inference

During inference, the multi-label POI categorization model learned in the training described above is given culture-specific inputs. The trained model then generates for each label a probability score. To provide a corresponding set of accepted labels from the probability score, a constant can be applied as threshold (e.g., 0.5, but can be larger or smaller).

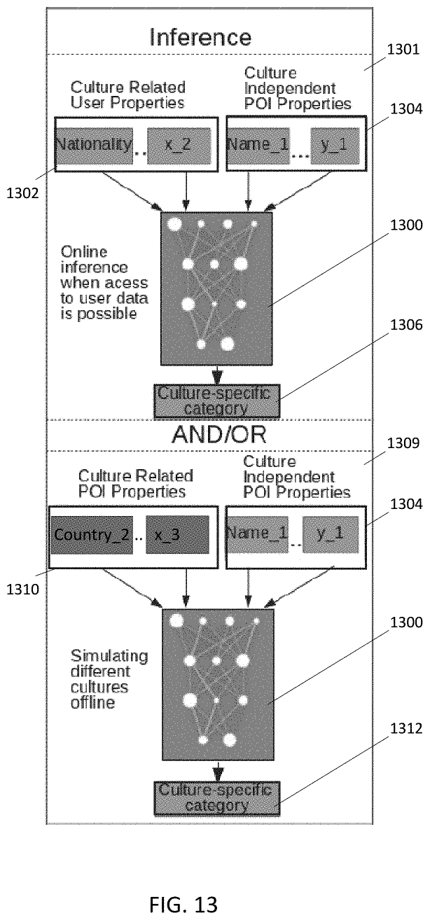

FIG. 13 shows example online and offline methods for inference using a trained neural network model 1300, e.g., after the training shown in FIG. 12. In the example online method 1301, a set of new culture-related user properties 1302 (e.g., Nationality, . . . , x_2, where Nationality refers to a region (e.g., country) corresponding to the users nationality) are input to the trained neural network model 1300. The set of culture-related user properties 1302 including the values of such properties is a subset of the culture-related POI properties 1202 input during training, but in the online inference method 1301, the user culture is used as context. A new set of culture independent properties 1304 (e.g., Name_1, . . . , y_1) is also input to the trained model 1300, which properties can be analogous to the POI properties 1304 input during training. These sets of properties can be concatenated into an input vector. The trained neural network model 1300 outputs a predicted POI semantic tag such as a culture-specific category 1306 (e.g., a category specific to a culture of the user).

In the example offline method 1309, on the other hand, a set of new culture-related POI properties 1310 (e.g., Country_2, . . . , x3, where Country_2 is a target country for the POI) and the set of new culture-independent POI properties 1304 are input to the trained neural network model 1300. The new culture-related POI properties 1310 including the values of such properties used at inference are a subset of the culture-related POI properties 1202 input to the (untrained) neural network model 1200 during training time. Thus, in the offline inference method 1309, different cultures are simulated using the culture-related POI properties 1310. The trained neural network model 1300 outputs a predicted POI semantic tag such as a culture-specific category 1312.

### EXPERIMENTS

Experiments were performed on 2.4M POIs extracted from Foursquare's database for illustrating example culture-aware POI category completion methods. The experimental dataset included 808 POI categories from the categorization hierarchy of Foursquare, as shown in Table 6. As the classification hierarchy was based on crowdsourced data, the parts of the dataset that included more POI instances were represented with more categories, resulting in it being heavily imbalanced. For instance, the most well-developed category located at the root of the hierarchy was Food, with 336 categories distributed in 5 levels. The least developed one was Residence having only 4 subcategories, over 2 levels.

TABLE 6
Category distribution in the dataset

| | | Categories in |
|---|---|---|
| Root Category | Levels | Path |
| Food | 5 | 337 |
| Shop & Service | 3 | 144 |
| Outdoors & Recreation | 4 | 83 |
| Professional & Other Places | 3 | 77 |
| Arts & Entertainment | 3 | 53 |
| Travel & Transport | 3 | 44 |
| College & University | 3 | 32 |
| Nightlife Spot | 3 | 25 |
| Event | 2 | 8 |
| Residence | 2 | 5 |

A sample dataset from the existing Foursquare database was extracted for experiments. The most well-developed root category, Food, was used as seed, and only POIs with a high reality index were taken. The distribution of the categories was similar to the one found in the original hierarchy, as shown in Table 7.

TABLE 7
Percentage & distribution of POIs to categories

| Category | POI perc. |
|---|---|
| Café | 9.83% |
| Restaurant | 5.88% |
| Pizza Place | 4.49% |
| Coffee Shop | 4.48% |
| Bakery | 3.80% |
| Fast Food Restaurant | 3.23% |
| . . . | . . . |
| Chinese Restaurant | 2.98% |
| Japanese Restaurant | 2.5% |
| Asian Restaurant | 2.41% |
| . . . | . . . |
| Noodle House | 1.02% |
| . . . | . . . |
| Ramen Restaurant | 0.65% |
| . . . | . . . |

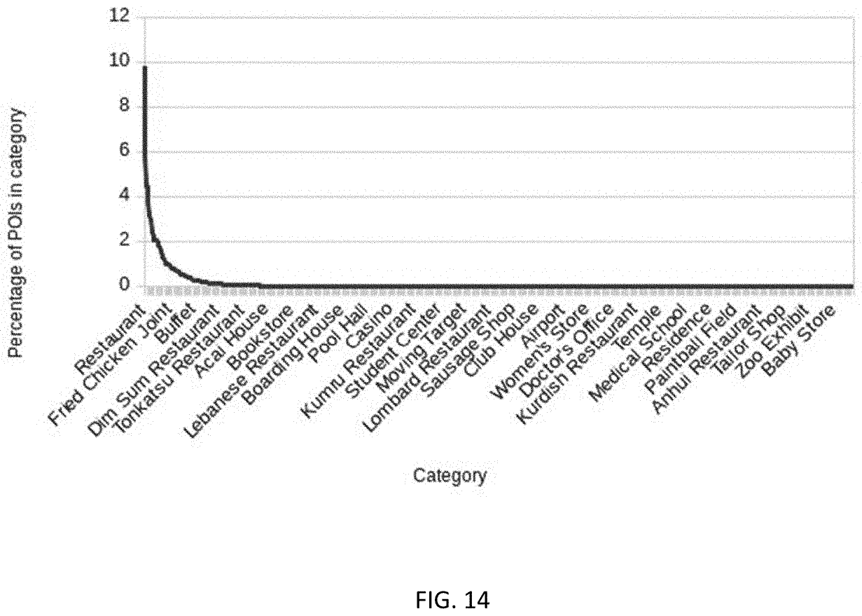

FIG. 14 shows the overall distribution of POIs and the one of the top categories in Table 7. The dataset was skewed in terms of the POI instances attributed to each category, with the first ten top categories having more than 40% of the POIs attributed to them.

To generate training, development, and test data, approximate stratified sampling was used. The goal was to maintain the distribution of positive and negative examples of each label by considering each label independently. Consequently, the experimental method allocated the POIs proportionally into 40% for training, 10% for development, and 50% for testing purposes. A relatively large percentage of the data was kept for testing purposes in order to have a large enough sample of POIs belonging to long tail categories, where cultural differences may be more apparent.

Model: For these experiments the neural network model architecture, hyperparameters, and hardware were the same as those described above for the temporal-based POI category completion model experiments. All the results provided below are on the test dataset, which was not used for training or validation purposes.

Results

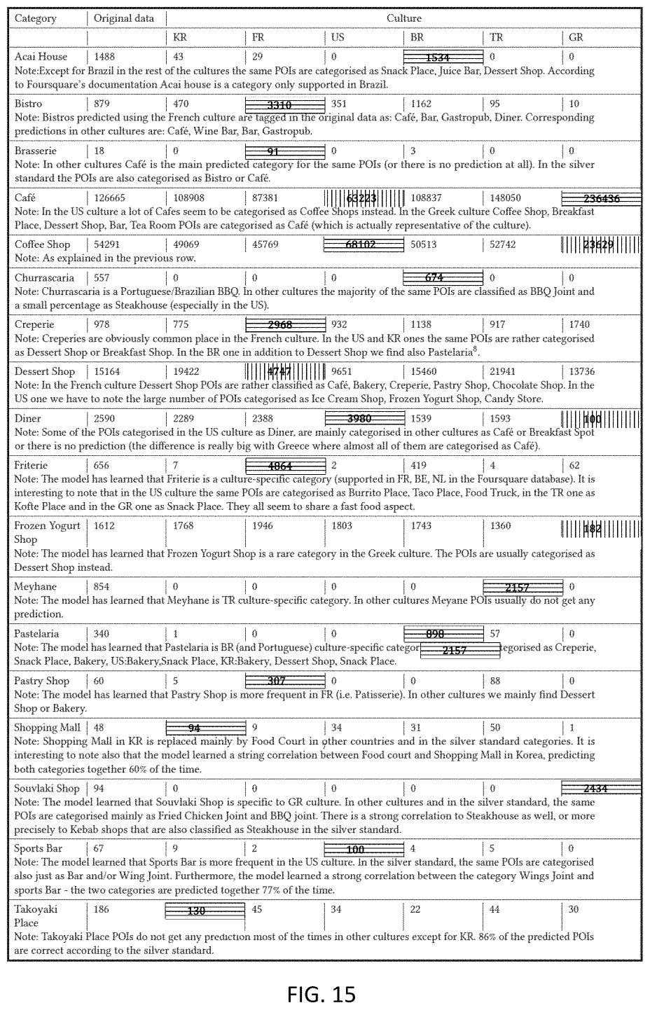

FIG. 15 shows how POIs were categorized in different cultures. As explained above, one's country was used as a proxy for culture in the experiments. The example model learned that some categories are by design (as defined by Foursquare) allowed only in specific countries, e.g. Acai House and Churrascaria are defined only in Brazil. Further, the predictions appeared to have reflected local culture reasonably well, e.g., Bistro and Creperie are quite popular in French culture and Souvlaki Shop in the Greek culture.

Additionally, it was observed that the predictions of culture-specific categories were predicted with appropriate categories in other cultures. For instance, Pastelaria, a typical Brazilian and Portuguese POI category, was predicted quite reasonably in other cultures as Bakery and/or Snack Place. Similarly, Churrascarias were classified as BBQ Joints in other cultures.

Further Applications Using Predicted POI Semantic Tags

Good quality POI semantic data is significant for providing meaningful and useful location-based services to users at any time. Example methods herein can provide automatic, multi-lingual methods for predicting POI semantic tags, such as categories. Only publicly available POI information need be used in example embodiments if desired, without the need to access third party resources (e.g., an external corpus) to obtain user information.

These predicted POI semantic tags can be used for any of various applications including but not limited to category completion, correction, and/or hierarchy generation or refinement, in global (multi-script/multi-language) crowdsourced databases. Separate neural models for one or more functionalities can be implemented in other example embodiments.

Automatic Semantic Tao Completion: As one example, predicted POI semantic tags resulting from imputation methods can be used to automatically complete POI categories for global databases (e.g., crowdsourced databases). As explained above, such methods can be performed offline, without access to user data if desired.

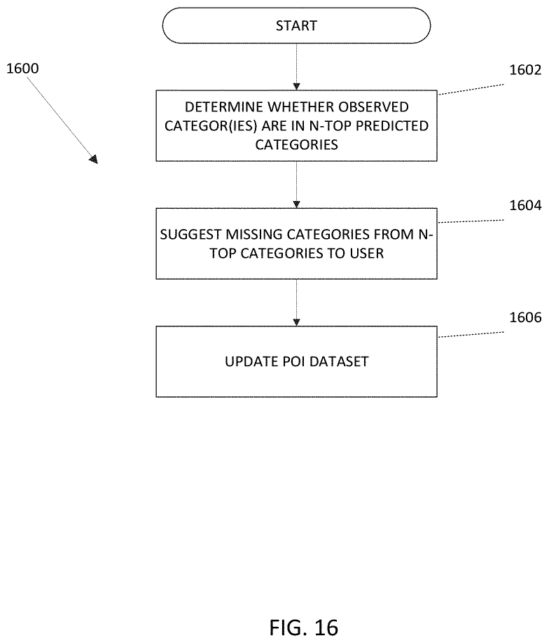

Automatic and Semi-automatic Semantic Tag Correction and Recommendation: FIG. 16 shows an example semantic tag (e.g., POI category) correction and/or recommendation method 1600 using predicted semantic tags according to methods disclosed herein. In the example method 1600, the processor 102 determines (e.g., checks) at 1602 whether the observed category(ies) are included in the n-top predicted categories (e.g., accepted as correct) provided by a POI semantic tag completion model such as those described above, where n can be a pre-defined (e.g., manually selected) threshold. A nonlimiting example number for n is 5. Other example methods may further take into account the delta (or a normalized form of it) between the probability score of the highest ranked prediction and the scores of the observed category(ies), in addition to their place in the n-top predictions.

The top n (or other selected amount) predictions can then be used to suggest possible missing categories at 1604, e.g., to a user via the user terminal 106a, 106b, and/or used (automatically or semi-automatically) to update the dataset at 1606. In an example semi-automatic method, the POI dataset can be updated by assigning one or more of the n-top predictions that are selected by the user after presenting then in step 1604. This example approach can be especially useful, for instance, in cases where the coverage of the semantic tag predictions is of higher priority rather than accuracy or precision.

Semantic Tag Hierarchical Recommendation and Semi-automatic Completion: Example semantic tag completion methods can also be used for providing hierarchical cues, e.g., visual and statistical cues, for POI semantic tags to users such as human curators. This can help the user, for instance, refine a database's semantic tags, e.g., by refining a corresponding schema or hierarchy of POI categories. A new category can be developed if one does not exist.

For example, consider a user writing a review for a POI, or an expert curating POI information. Selecting the right POI metadata when completing the review or curating can be time-consuming. It is useful to automatically recommend appropriate metadata, including POI categories, to facilitate such tasks as much as possible. One or more automatically predicted individual POI semantic tags can be provided to the user using methods disclosed herein.

Additionally or alternatively, using automatically predicted semantic tags for POIs, visual and/or statistical hints can be provided to a human curator regarding the similarity of different categories, as opposed to focusing on individual POIs. For instance, category tree refinement can be provided, e.g., by providing visual, statistical, or other cues to human curators, e.g., via the user terminal 106a, 106b, to help the user semi-automatically correct the hierarchy of categories (or other semantic tags) and/or create one.

For example, to provide statistical cues, the co-occurrence frequency of predicted labels can be calculated to find pairs of labels that co-occur more frequently than a pre-defined threshold. For instance, if “Greek Restaurant” and “Mediterranean Restaurant” are predictions that co-occur >80% of the time, and no hierarchical relation between the two exists in a corresponding category hierarchy, then the pair can be forwarded to a human (e.g., an expert), as a curation candidate.

As an example of providing visual cues, the second (e.g., last) layer of activations in an example neural network architecture as described in example methods herein can be understood as an embedding of the POI categories (or other tags). A dimensionality reduction technique can be used to help reduce the high-dimensional embeddings into lower-dimensions and allow visualization of them in a 2D or 3D manner. Known techniques and frameworks for dimensionality reduction and visualization may be used, such as but not limited to principal component analysis (PCA) or t-distributed stochastic neighbor embedding (t-SNE) (for dimensionality reduction) in combination with visualization toolkits such as Tensorboard or matplotiib. The corresponding visualization can then be provided to a human curator, e.g., generated for displaying in one or more suitable forms via the user terminal 106a, 106b, to provide suggestions for which categories are close in this latent space and thus should be linked or modified in the category hierarchy.

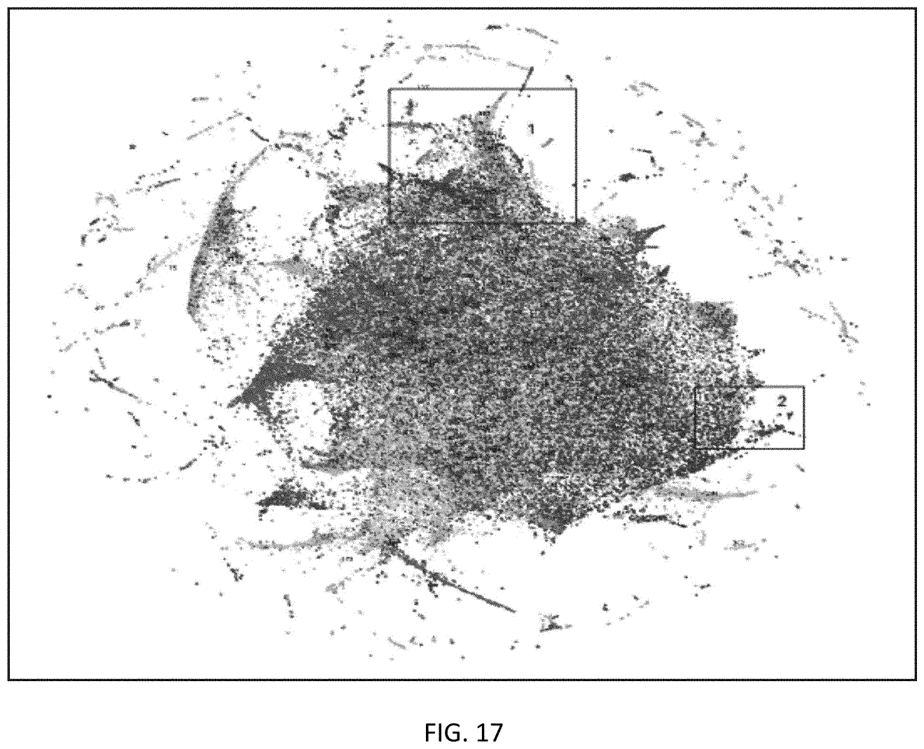

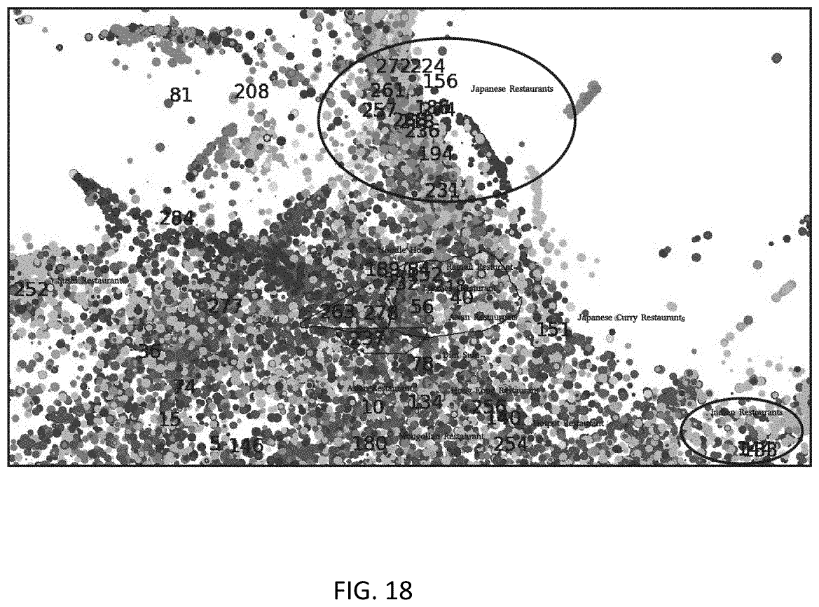

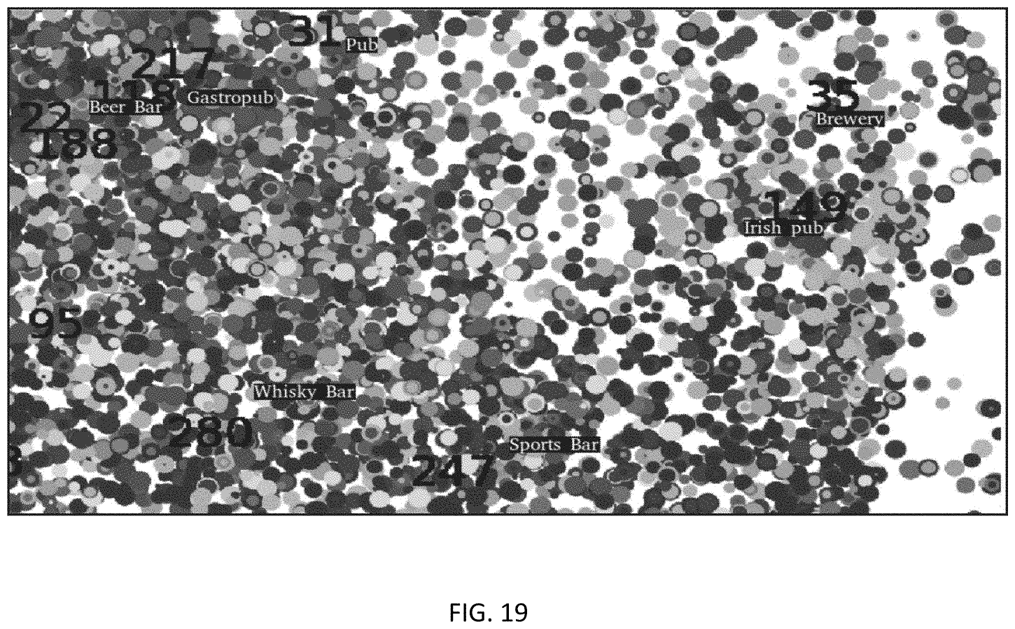

FIG. 17 shows an example hierarchical visualization, after filtering out rare labels (each label filtered out had fewer than five POIs attributed to it). Different colors represent different labels. FIGS. 18-19 show additional example visualizations enlarging zones 1 and 2 in FIG. 17 respectively. In FIGS. 18-19, in addition to colors a number is projected representing each category. The numbers are used in the example visualization as they are shorter than category names, and thus the resulting image is less cluttered. However, other category representations are possible. The median of the coordinates of all POIs of a category is used to position the number in the example 2D space.

In FIG. 18, it can be seen that all the Japanese restaurants are clustered together, which conforms to the corresponding part of the manually created Foursquare hierarchy (as shown by the Japanese Restaurant subcategories). However, in addition, it can be seen that the Ramen Restaurant is very close to the Noodle House category, which is in turn in the middle of Asian restaurant related categories. In the Foursquare category, no relation exists between Noodle House, Ramen Restaurant, and other Asian types of restaurants.

In FIG. 19, it can be seen that Pub, Gastropub, and Beer Bar are close to each other, confirming the fact that they are all subcategories of Bar. However, one also finds Irish Pub close to Pub, two categories that have no link in the current Foursquare hierarchy.

Assisted Search Using Predicted POI Categories

Proper POI categorization can also help with recommendation of POIs. Accordingly, other example applications herein provide search results and recommendations in response to a POI search.

For instance, a user that may not be familiar with local culture may wish to search for appropriate POIs in the vicinity of his/her position. Using appropriate categories for POIs allows the user to more easily search for POIs by providing them in the search results. If POIs are not categorized under the appropriate type, the user cannot easily search for them, and they will not be included in the search results. Further, for an example POI recommendation application, proper POI categorization can assist with recommending possible POI alternatives in response to a search request.

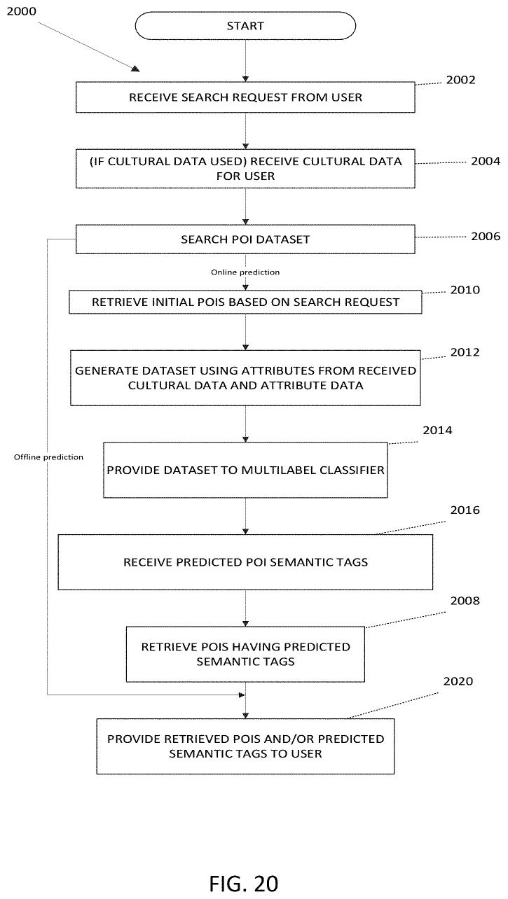

FIG. 20 shows an example method 2000 for recommending a POI to a user. The method 2000 may be performed, for instance, using the processor 102. The POI is represented by attribute data stored in a data storage, e.g., a database, as explained elsewhere herein.

A search request is received for a POI from the user at 2002, e.g., via the user terminal 106a, 106b. This search request can include one or more POI categories. Additionally, the search request may include a geographic location, which can be obtained, for instance, directly from a user input, by retrieving user location information using known methods, etc. If culture-aware data is to be considered, cultural data for the user may also be received at 2004.

In response to the search request, the data storage is searched at 2006, and POIs are retrieved at 2008. For instance, POIs may be retrieved in part based on spatial attribute data corresponding to the received geographic location (if one is received) or by other search criteria provided in the search request.

The criteria for the search 2006 also includes POIs having one or predicted semantic tags corresponding to one or more of the received POI categories. For instance, if appropriate semantic tags have been predicted for POIs (e.g., offline), one or more of the POIs having predicted semantic tags corresponding to one or more of the received POI categories can be retrieved in step 2008. The predicted semantic tags can be compared to the one or more categories in the search request to determine whether the POI categories correspond. Correspondence can include, for instance, matching the received category or being related to the received category in a hierarchy of categories stored in the data storage.

If appropriate semantic tags have not yet been predicted, for instance where cultural data for a user is to be considered for an online search, a set of initial POIs can be retrieved at 2010 based on any of various search criteria in the request. Then, to account for the user culture, for each of the retrieved one or more initial POIs, a dataset can be generated at 2012 corresponding to a selected set of attributes from the received cultural data and the received attribute data for the retrieved POI. This selected set of attributes can include at least one cultural attribute that is generated from the received cultural data. An example dataset can include, for instance, data attributes such as those provided herein for culture-aware POI semantic tag completion.

The generated dataset (for each initially retrieved POI) is provided to the multilabel classifier at 2014, and one or more predicted semantic tags are received for the respective POI from an output of the multilabel classifier at 2016. The predicted semantic tags for the one or more POIs can then be compared to the one or more categories so that (here, online) predicted semantic tags corresponding to one or more of the received POI categories can be selected for retrieval in step 2008.

At least one of the retrieved POIs from step 2008 is then provided to the user at 2020, e.g., via the user terminal 106a, 106b. The number of provided POIs can be selected in any suitable way, and POIs can be filtered, sorted, etc., using methods that will be apparent to those of ordinary skill in the art. Identification information (text, icons, images or highlighted portions (e.g., map portions)) for retrieved POIs can be generated for display on a display of the user terminal 106a, 106b.

General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A method for automatically assigning one or more semantic tags to a point-of-interest (POI) using a processor, the POI being represented by attribute data, the method comprising:
receiving the attribute data for the POI, the attribute data comprising temporal attribute data and one or more of spatial attribute data or metadata;
providing the received attribute data to a multilabel classifier comprising a neural network model;
receiving one or more predicted semantic tags for the POI from an output of the multilabel classifier; and
storing the predicted semantic tags in a database as additional attribute data of the POI.

2. The method of claim 1, wherein the predicted semantic tags comprise category labels for the POI;
wherein the category labels are taken from a label set stored in the database.

3. The method of claim 2, wherein the metadata comprises one or more observed semantic tags for the POI;
wherein the one or more semantic tags comprise category labels taken from the label set.

4. The method of claim 1, wherein the metadata comprises a unique identifier for the POI.

5. The method of claim 1, wherein the spatial attribute data comprises geospatial data.

6. The method of claim 1, wherein the temporal data comprises one or more of opening times, closing times, or access times for the POI.

7. The method of claim 1, wherein said providing the received attribute data to a multilabel classifier comprises:
vectorizing the received attribute data;
concatenating the vectorized data; and
inputting the concatenated data to the multilabel classifier.

8. The method of claim 7, wherein the received attribute data comprises at least one categorical variable; and
wherein said vectorizing comprises representing the at least one categorical variable by one-hot encoding.

9. The method of claim 7, wherein the received attribute data comprises at least one sequential variable; and
wherein said vectorizing comprises processing the at least one sequential variable using an n-gram character-based long short-term memory (LSTM) model.

10. The method of claim 7, wherein the received attribute data comprises at least one spatial variable;
wherein said vectorizing comprises one or more of:
modeling the at least one spatial variable using a discretized input space; or
mapping the at least one spatial variable to a geographical region represented by a categorical variable or a sequential variable.

11. The method of claim 7, wherein said vectorizing comprises one or more of:
representing the temporal data as a categorical variable using one-hot encoding;
representing the temporal data as a periodic variable by transforming the temporal data into one or more vectors respectively representing dimensions of the temporal data; or
representing the temporal data as a formatted string using an n-gram character based long short-term memory (LSTM) model.

12. The method of claim 1, wherein the predicted semantic tags comprise category labels for the POI;
wherein the category labels are taken from a label set stored in the database; and
wherein the received one or more predicted semantic tags comprises a probability score for each of the category labels in the label set.

13. The method of claim 12, further comprising:
selecting the received one or more predicted semantic tags for which the probability score meets or exceeds a threshold.

14. The method of claim 1, wherein the multilabel classifier comprises a neural network model.

15. The method of claim 1, wherein the method further comprises:
providing a training set, wherein said providing comprises:
filtering attribute data for each of a plurality of POIs, wherein the filtered attribute data comprises the temporal attribute data and metadata, the metadata comprising at least one semantic tag;
for each of the plurality of POIs, selecting the at least one semantic tag to be completed as a target; and
vectorizing a remainder of the filtered attribute data to provide training data for the training set; and
training the multilabel classifier using the provided training set.

16. The method of claim 15, wherein the filtered attribute data for each of the plurality of POIs comprises POI names;
wherein the POI names among the plurality of POIs are represented by a plurality of languages and/or scripts.

17. The method of claim 1, wherein the database comprises a global crowdsourced database.

18. The method of claim 1, wherein the attribute data provided to the multilabel classifier does not include attribute data derived from user check-ins.

19. The method of claim 1, wherein the received attribute data does not include attribute data derived from user check-ins.

20. The method of claim 1, wherein said automatically assigning one or more semantic tags is in response to a user input via a user terminal;
wherein the method further comprises:
providing one or more of the predicted semantic tags to the user via the user terminal.

21. The method of claim 20, wherein the user input comprises the POI or a search request for a POI.

22. The method of claim 20, wherein the user input comprises a proposed semantic tag; and
wherein said providing one or more semantic tags to the user comprises providing additional or alternative semantic tags to the proposed semantic tag.

23. The method of claim 22, wherein the user input further comprises the POI or a search request for a POI.

24. The method of claim 22, wherein said provided one or more semantic tags comprise one or more tags related to the proposed semantic tag in a hierarchy.

25. The method of claim 24, wherein said providing the one or more semantic tags comprises generating for display on the user terminal a visualization of the one or more related semantic tags.

26. The method of claim 1, further comprising:
receiving a search request for a POI from a user via a user terminal, the search request comprising a category and a geographic location;
in response to said request, searching the database;
retrieving one or more POIs having spatial attribute data corresponding to the received geographic location and having one or more of the predicted semantic tags corresponding to the received category; and
generating for displaying on the user terminal the retrieved one or more POIs.

27. The method of claim 26, wherein the retrieved one or more predicted semantic tags match the received category.

28. The method of claim 26, wherein the retrieved one or more predicted semantic tags are related to the received category in a hierarchy of categories stored in the database.

29. A method for automatically assigning one or more semantic tags to a point-of-interest (POI) using a processor, the POI being represented by attribute data stored in a database, the method comprising:
receiving a request from a user via a user terminal;
receiving cultural data for the user;
in response to the request, receiving the attribute data for the POI from the database;
generating a dataset including data corresponding to a selected set of attributes from the received cultural data and the received attribute data for the POI, the selected set of attributes comprising a POI name for the POI and at least one cultural attribute, wherein the data corresponding to the at least one cultural attribute in the generated dataset is generated from the received cultural data;
providing the generated dataset to a multilabel classifier comprising a neural network model;
receiving one or more predicted semantic tags for the POI from an output of the multilabel classifier; and
providing the received one or more predicted semantic tags to the user via the user terminal;
wherein the multilabel classifier is trained for predicting one or more semantic tags for each of a plurality of POIs in the database using a plurality of training sets, wherein each training set corresponds to the selected set of attributes, and wherein the data corresponding to the at least one cultural attribute in each of the training sets is generated from culture-related POI attributes.

30. The method of claim 29, wherein the predicted semantic tags comprise category labels for the POI;
wherein the category labels are taken from a label set stored in the database.

31. The method of claim 29, wherein the selected set of attributes comprises temporal attributes for the POI.

32. The method of claim 29, wherein the at least one cultural attribute comprises one or more prices for services corresponding to the POI.

33. The method of claim 29, wherein the received cultural data comprises one or more of a geographic region of the user and a nationality of the user.

34. The method of claim 29, wherein said generating the dataset comprises:
vectorizing the data corresponding to the selected set of attributes;
concatenating the vectorized data; and
inputting the concatenated data to the multilabel classifier.

35. The method of claim 34, wherein the selected set of attributes comprises at least one categorical variable; and
wherein said vectorizing the data corresponding to the at least one categorical variable comprises one-hot encoding.

36. The method of claim 34, wherein the selected set of attributes comprises at least one sequential variable; and
wherein said vectorizing data corresponding to the at least one sequential variable comprises processing the at least one sequential variable using an n-gram character-based long short-term memory (LSTM) model.

37. The method of claim 34, wherein the selected set of attributes comprises at least one spatial variable;
wherein said vectorizing comprises one or more of:
modeling the data corresponding to the at least one spatial variable using a discretized input space; or
mapping the data corresponding to the at least one spatial variable to a geographical region represented by a categorical variable or a sequential variable.

38. The method of claim 34, wherein the selected set of attributes comprises a temporal variable;
wherein said vectorizing comprises one or more of:
representing the data corresponding to the temporal variable as a categorical variable using one-hot encoding;
representing the data corresponding to the temporal variable as a periodic variable by transforming the temporal data into one or more vectors respectively representing dimensions of the temporal data; or
representing the data corresponding to the temporal variable as a formatted string using an n-gram character based long short-term memory (LSTM) model.

39. The method of claim 29, wherein the predicted semantic tags comprise category labels for the POI;
wherein the category labels are taken from a label set stored in the database; and
wherein the received one or more predicted semantic tags comprises a probability score for each of the category labels in the label set;
wherein the method further comprises selecting the received one or more predicted semantic tags for which the probability score meets or exceeds a threshold.

40. The method of claim 29, wherein the method further comprises:
receiving attribute data from the database for the plurality of POIs;
generating the plurality of training sets using the received attribute data; and
training the multilabel classifier using the generated training sets.

41. The method of claim 40, wherein said generating the plurality of training sets comprises:
vectorizing the received attribute data corresponding to the selected set of attributes;
concatenating the vectorized data; and
inputting the concatenated data to the multilabel classifier.

42. The method of claim 40, wherein the received attribute data does not include attribute data derived from user check-ins.

43. The method of claim 40, wherein the received request comprises a search request for one or more POIs; and
wherein said receiving the attribute data for the POI comprises:
retrieving the POI in response to the search request.

44. The method of claim 39, wherein the received request comprises a proposed semantic tag; and
wherein said providing one or more semantic tags to the user comprises providing additional or alternative semantic tags to the proposed semantic tag.

45. The method of claim 39, wherein said providing the one or more semantic tags comprises generating for display on the user terminal a visualization of the one or more related semantic tags.

46. A method for automatically assigning one or more semantic tags to a point-of-interest (POI) using a processor, the POI being represented by attribute data stored in a database, the method comprising:
receiving culture-related POI target data;
receiving the attribute data for the POI from the database;
generating a dataset including data corresponding to a selected set of attributes from the received cultural data and the received culture-related POI target data for the POI, the selected set of attributes comprising a POI name for the POI and at least one cultural attribute, wherein the data corresponding to the at least one cultural attribute in the generated dataset is generated from the received culture-related POI target data;
providing the generated dataset to a multilabel classifier comprising a neural network model;
receiving one or more predicted semantic tags for the POI from an output of the multilabel classifier; and
storing at least a portion of the received one or more predicted semantic tags for the POI in the database;
wherein the multilabel classifier is trained for predicting one or more semantic tags for each of a plurality of POIs in the database using a plurality of training sets, wherein each training set corresponds to the selected set of attributes, and wherein the data corresponding to the at least one cultural attribute in each of the training sets is generated from culture-related POI attributes.

47. The method of claim 46, wherein the received culture-related POI target data comprises a geographic region of a target POI, wherein the target POI is selected to simulate a user geographic region.

48. A method for recommending to a user a point-of-interest (POI) using a processor, the POI being represented by attribute data stored in a database, the method comprising:
receiving a search request for a POI from the user via a user terminal, the search request including one or more categories;
receiving cultural data for the user;
in response to the search request, searching the database and retrieving attribute data for one or more POIs from the database;
for each of the retrieved one or more POIs:
generating a dataset including data corresponding to a selected set of attributes from the received cultural data and the received attribute data for the POI, the selected set of attributes comprising at least one cultural attribute, wherein the data corresponding to the at least one cultural attribute in the generated dataset is generated from the received cultural data;
providing the generated dataset to a multilabel classifier comprising a neural network model; and
receiving one or more predicted semantic tags for the POI from an output of the multilabel classifier;
comparing the predicted semantic tags for the one or more POIs to the one or more categories in the search request; and
based on said comparing, selecting at least one of the retrieved POIs and providing the at least one selected POI to the user via the user terminal;
wherein the multilabel classifier is trained for predicting one or more semantic tags for each of a plurality of POIs in the database using a plurality of training sets, wherein each training set corresponds to the selected set of attributes, and wherein the data corresponding to the cultural attribute in each of the training sets is generated from culture-related POI attributes.

49. The method of claim 48, wherein the received cultural data comprises one or more of a geographic region of the user and a nationality of the user.
